(19) United States
(12) Patent Application Publication
(10) Pub. No.: US 2022/0408825 A1
(43) Pub. Date: Dec. 29, 2022

(54) AEROSOL PROVISION DEVICE

(71) Applicant: Nicoventures Trading Limited, London (GB)

(72) Inventors: Walid ABI AOUN, London (GB); Thomas Paul BLANDINO, Cottage Grove, WI (US); Elizabeth BUCKLAND, London (GB); Richard John HEPWORTH, London (GB); Ashley John SAYED, London (GB); Luke James WARREN, London (GB); Thomas Alexander John WOODMAN, London (GB)

(21) Appl. No.: 17/823,221

(22) Filed: Aug. 30, 2022

Related U.S. Application Data
(63) Continuation of application No. 17/593,133, filed on Sep. 10, 2021.
(60) Provisional application No. 62/816,255, filed on Mar. 11, 2019.
(60) Provisional application No. 62/816,339, filed on Mar. 11, 2019.

(30) Foreign Application Priority Data
Mar. 11, 2019 (GB) 1903240.8
Mar. 11, 2019 (GB) 1903253.1

(51) Int. Cl. A24F 40/465; A24F 40/20; A24F 40/42; H05B 6/44

(52) U.S. Cl. CPC A24F 40/465; A24F 40/20; A24F 40/42; H05B 6/44

(57) ABSTRACT

An aerosol provision device is provided. The device defines a longitudinal axis, and comprises a first coil and a second coil. The first coil is configured to heat a first section of a heater component, the heater component being configured to heat aerosol generating material to generate an aerosol. The second coil is configured to heat a second section of the heater component. The first coil has a first length along the longitudinal axis and the second coil has a second length along the longitudinal axis, the first length being shorter than the second length. The first coil is adjacent the second coil in a direction along the longitudinal axis. In use, the aerosol is drawn along a flow path of the device towards a proximal end of the device, and the first coil is arranged closer to the proximal end of the device than the second coil.

### CROSS-REFERENCE TO RELATED APPLICATIONS

The present application is a Continuation application of U.S. Non-Provisional application Ser. No. 17/593,133, filed Sep. 10, 2021, which is a National Phase entry of PCT Application No. PCT/EP2020/056217, filed Mar. 9, 2020, which claims priority from Great Britain Application No. 1903240.8, filed Mar. 11, 2019, and which claims priority from U.S. Provisional Application No. 62/816,255, filed Mar. 11, 2019, and which claims priority from U.S. Provisional Application No. 62/816,339, filed Mar. 11, 2019, and which claims priority from Great Britain Application No. 1903253.1, filed Mar. 11, 2019, each of which is hereby fully incorporated herein by reference.

### TECHNICAL FIELD

The present invention relates to an aerosol provision device.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to a first aspect of the present disclosure, there is provided an aerosol provision device defining a longitudinal axis, the device comprising:

a first coil and a second coil, wherein:
the first coil is configured to heat a first section of a heater component, the heater component being configured to heat aerosol generating material to generate an aerosol;
the second coil is configured to heat a second section of the heater component;
the first coil has a first length along the longitudinal axis and the second coil has a second length along the longitudinal axis, the first length being shorter than the second length;
the first coil is adjacent the second coil in a direction along the longitudinal axis; and
in use, the aerosol is drawn along a flow path of the device towards a proximal end of the device, and the first coil is arranged closer to the proximal end of the device than the second coil.

According to a second aspect of the present disclosure there is provided an aerosol provision device defining a longitudinal axis, the device comprising:

a first inductor coil and a second inductor coil, wherein:
the first inductor coil is configured to generate a first varying magnetic field for heating a first section of a susceptor arrangement, the susceptor arrangement being configured to heat aerosol generating material to generate an aerosol;
the second inductor coil is configured to generate a second varying magnetic field for heating a second section of the susceptor arrangement;
the first inductor coil has a first length along the longitudinal axis and the second inductor coil has a second length along the longitudinal axis, the first length being shorter than the second length;
the first inductor coil is adjacent the second inductor coil in a direction along the longitudinal axis; and
in use, the aerosol is drawn along a flow path of the device towards a proximal end of the device, and the first inductor coil is arranged closer to the proximal end of the device than the second inductor coil.

According to a third aspect of the present disclosure, there is provided an aerosol provision device defining a longitudinal axis, the device comprising:

a first coil and a second coil, wherein:

the first coil is configured to heat a first section of a heater component, the heater component being configured to heat aerosol generating material to generate an aerosol;

the second coil is configured to heat a second section of the heater component;

the first coil has a first length along the longitudinal axis and the second coil has a second length along the longitudinal axis;

the first coil is adjacent the second coil in a direction along the longitudinal axis; and

the ratio of the second length to the first length is greater than about 1.1.

According to fourth aspect of the present disclosure, there is provided an aerosol provision device defining a longitudinal axis, the device comprising:

a first inductor coil and a second inductor coil, wherein:
the first inductor coil is configured to generate a first varying magnetic field for heating a first section of a susceptor arrangement, the susceptor arrangement being configured to heat aerosol generating material to generate an aerosol;
the second inductor coil is configured to generate a second varying magnetic field for heating a second section of the susceptor arrangement;
the first inductor coil has a first length along the longitudinal axis and the second inductor coil has a second length along the longitudinal axis;
the first inductor coil is adjacent the second inductor coil in a direction along the longitudinal axis; and
the ratio of the second length to the first length is greater than about 1.1.

According to fifth aspect of the present disclosure, there is provided an aerosol provision device defining a longitudinal axis, the device comprising:

a heating arrangement comprising a first heater component and a second heater component, wherein:
the first heater component is configured to heat a first section of aerosol generating material received in the aerosol provision device, thereby to generate an aerosol;
the second heater component is configured to heat a second section of the aerosol generating material thereby to generate an aerosol;
the first heater component has a first length along the longitudinal axis and the second heater component has a second length along the longitudinal axis;
the first heater component is adjacent the second heater component in a direction along the longitudinal axis; and
the ratio of the second length to the first length is between about 1.1 and about 1.5.

According to a sixth aspect of the present disclosure, there is provided an aerosol provision device, comprising:

a first inductor coil configured to generate a varying magnetic field for heating a susceptor, wherein the susceptor defines a longitudinal axis and is configured to heat aerosol generating material to generate an aerosol;

wherein:

the first inductor coil is helical and has a first length along the longitudinal axis;

the first inductor coil has a first number of turns around the susceptor, and

a ratio of the first number of turns to the first length is between about 0.2 mm⁻¹ and about 0.5 mm⁻¹.

According to a seventh aspect of the present disclosure, there is provided an aerosol provision device, comprising:

a first inductor coil and a second inductor coil, wherein:

the first inductor coil is configured to generate a first varying magnetic field for heating a first section of a susceptor arrangement, the susceptor arrangement being configured to heat aerosol generating material to generate an aerosol;

the second inductor coil is configured to generate a second varying magnetic field for heating a second section of the susceptor arrangement;

the first inductor coil has a first number of turns around an axis defined by the susceptor;

the second inductor coil has a second number of turns around the axis; and

the ratio of the second number of turns to the first number of turns is between about 1.1 and about 1.8.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a front view of an example of an aerosol provision device;

FIG. 2 shows a front view of the aerosol provision device of FIG. 1 with an outer cover removed;

FIG. 3 shows a cross-sectional view of the aerosol provision device of FIG. 1;

FIG. 4 shows an exploded view of the aerosol provision device of FIG. 2;

FIG. 5A shows a cross-sectional view of a heating assembly within an aerosol provision device;

FIG. 5B shows a close-up view of a portion of the heating assembly of FIG. 5A;

FIG. 6 shows a first example of first and second inductor coils wrapped around an insulating member;

FIG. 7 shows a first example of the first inductor coil;

FIG. 8 shows a first example of the second inductor coil;

FIG. 9 shows a diagrammatic representation of a cross section of first and second inductor coils, a susceptor and an insulating member;

FIG. 10 shows a second example of first and second inductor coils wrapped around an insulating member;

FIG. 11 shows a second example of the first inductor coil;

FIG. 12 shows a second example of the second inductor coil;

FIG. 13 shows a diagrammatic representation of cross section of a litz wire;

FIG. 14 shows a diagrammatic representation of a top down view of an inductor coil; and

FIG. 15 shows another diagrammatic representation of a cross section of first and second inductor coils, a susceptor and an insulating member.

### DETAILED DESCRIPTION OF THE DRAWINGS

As used herein, the term “aerosol generating material” includes materials that provide volatilized components upon heating, typically in the form of an aerosol. Aerosol generating material includes any tobacco-containing material and may, for example, include one or more of tobacco, tobacco derivatives, expanded tobacco, reconstituted tobacco or tobacco substitutes. Aerosol generating material also may include other, non-tobacco, products, which, depending on the product, may or may not contain nicotine. Aerosol generating material may for example be in the form of a solid, a liquid, a gel, a wax or the like. Aerosol generating material may for example also be a combination or a blend of materials. Aerosol generating material may also be known as “smokable material”.

Apparatuses are known that heat aerosol generating material to volatilize at least one component of the aerosol generating material, typically to form an aerosol which can be inhaled, without burning or combusting the aerosol generating material. Such an apparatus is sometimes described as an “aerosol generating device,” an “aerosol provision device,” a “heat-not-burn device,” a “tobacco heating product device,” or a “tobacco heating device” or similar. Similarly, there are also so-called e-cigarette devices, which typically vaporize an aerosol generating material in the form of a liquid, which may or may not contain nicotine. The aerosol generating material may be in the form of or be provided as part of a rod, cartridge or cassette or the like which can be inserted into the apparatus. A heater for heating and volatilizing the aerosol generating material may be provided as a “permanent” part of the apparatus.

An aerosol provision device can receive an article comprising aerosol generating material for heating. An “article” in this context is a component that includes or contains in use the aerosol generating material, which is heated to volatilize the aerosol generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article.

A first aspect of the present disclosure defines a first coil and a second coil. The first coil has a first length, and the second coil has a second length, where the first length is shorter than the second length. The first coil is arranged closer to the proximal end of the device. The proximal end of the device is the end which is closest to the mouth of the user, when the user is drawing on the device to inhale aerosol. Thus, the proximal end is the end towards which aerosol travels, as the user inhales.

Both the first and second coils are arranged to heat a heater component such as a susceptor (possibly at different times). As will be discussed in more detail herein, a susceptor is an electrically conducting object, which is heatable by varying magnetic fields. The first coil may be a first inductor coil configured to generate a first magnetic field. The second coil may be a second inductor coil configured to generate a second magnetic field. The first coil can cause a first section of the heater component to be heated, and the second coil can cause a second section of the heater component to be heated. An article comprising aerosol generating material can be received within the heater component, or be arranged near to, or in contact with the heater component. Once heated, the heater component transfers heat to the aerosol generating material, which releases aerosol. In one example, the heater component defines a receptacle and the heater component receives the aerosol generating material.

As mentioned, the first coil may be a first inductor coil, the second coil may be a second inductor coil and the heater component may be a susceptor (also known as a susceptor arrangement). The first inductor coil is configured to generate a first varying magnetic field for heating a first section of a susceptor arrangement. The second inductor coil is configured to generate a second varying magnetic field for heating a second section of the susceptor arrangement.

The end of the susceptor which is closest to the proximal end of the device is surrounded by the first, shorter coil. Once aerosol generating material is received within the device, aerosol generating material that is arranged towards the proximal end of the device is heated as a result of the first, shorter coil.

It has been found that by having a shorter coil arranged closer to the proximal end of the device, the phenomenon known as “hot puff” can be reduced or avoided. “Hot puff” is where a user's first puff on the device is too hot (i.e., the aerosol the user inhales is too hot). This can potentially cause discomfort or harm to the user. Hot puff occurs because the ratio of hot aerosol to cooler air is higher than is desired.

By having a shorter coil arranged closer to the distal end of the aerosol generating material (which is heated first), a smaller volume of aerosol generating material is heated. This reduces the volume of aerosol that is produced than would have been produced had a larger volume of material been heated. This aerosol is mixed with a volume of ambient/cooler air in the device, and the temperature of the aerosol is lowered, thereby avoiding/reducing hot puff. The longer coil heats a larger volume of aerosol generating material to produce more aerosol, which is mixed with the same or similar volume of ambient/cooler air. However, compared to the aerosol produced by the first coil, this aerosol mixture travels further through the device and further through the remaining aerosol generating material before being inhaled. Because the aerosol has further to travel, it is additionally cooled to an acceptable level. Hot puff can be caused by water or water vapor in the aerosol. A shorter coil may liberate a smaller volume of water or water vapor. For example, in aerosol generating material with a 15% water content, a length of about 42 mm, and a mass of about 260 mg, the mass of water liberated by a coil having a first length of about 14 mm is about 13 mg.

In the device, a first portion of aerosol generating material is heated by the first section of the susceptor, and the first portion is smaller than a second portion of aerosol generating material that is heated by the second section of the susceptor.

The first and second lengths are measured in a direction parallel to a longitudinal axis of the device. In another example, the first and second lengths are measured in a direction parallel to a longitudinal axis, for example an insertion axis into the device, or a longitudinal axis of the susceptor. In general, the longitudinal axis of the device and the longitudinal axis of the susceptor are parallel. In other words, the susceptor arrangement is arranged parallel to the longitudinal axis of the device.

The first and second lengths may be chosen such that aerosol produced by the first portion of the aerosol generating material leaves the device at a first temperature, and aerosol produced by the second portion of the aerosol generating material leaves the device at a second temperature, where the first and second temperatures are substantially the same.

In certain arrangements the first and second coils are activated independently of each other. Thus, while the first coil is operative, the second coil may be inactive. In some examples the first and second coils operate at the same time for a certain length of time. In some examples, the device comprises a controller, and the controller can operate the device in two or more heating modes. For example, in a first mode, the first and second coils may be operated for a particular length of time, and/or heat the aerosol generating material to a particular temperature. In a second mode, the first and second coils may be operated for a different length of time, and/or heat the aerosol generating material to a different temperature.

In a particular example, the aerosol provision device comprises the susceptor arrangement. In other examples, an article comprising aerosol generating material comprises the susceptor arrangement.

The device may further comprise a mouthpiece/opening arranged at the proximal end of the device, wherein the first coil is positioned closer to the mouthpiece than the second coil. The mouthpiece may be removably affixed to an opening of the device, or the opening of the device may itself define a mouthpiece. In a particular example, an article comprising the aerosol generating material is inserted into the device and extends out of the opening of the device while it is being heated. Thus, the aerosol flows out of the opening, but is contained within the article as it does so. In such a case, the opening may still be said to be a mouthpiece, regardless of whether it comes into contact with the user's mouth in use.

In certain arrangements, an outer perimeter of the first coil is positioned away from the susceptor by substantially the same distance as an outer perimeter of the second coil. In other words, the coils do not overlap each other. Such an arrangement can simplify the assembly process of the device. For example, the two coils can be wrapped around an insulating member. Reference to the “outer perimeter” or “outer surface” of the coil means the edge/surface positioned furthest away from the susceptor arrangement, in a direction perpendicular to the longitudinal axis of the device and/or susceptor arrangement. Similarly, reference to an “inner perimeter/surface” of the coil means the edge/surface positioned closest to the susceptor arrangement, in a direction perpendicular to the longitudinal axis of the device and/or susceptor arrangement. Accordingly, the first and second coils may have substantially the same external diameter.

In one example, the inner diameter of the first and/or second coils is about 10-14 mm in length, and the outer diameter is about 12-16 mm in length. In a particular example, the inner diameter of the first and second coils is about 12-13 mm in length, and the outer diameter is about 14-15 mm in length. Preferably the inner diameter of the first and second coils is about 12 mm in length, and the outer diameter is about 14.6 mm in length. The inner diameter of a helical coil is any straight line segment that passes through the center of the coil (as viewed in cross section) and whose endpoints lie on the inner perimeter of the coil. The outer diameter of a helical coil is any straight line segment that passes through the center of the coil (as viewed in cross section) and whose endpoints lie on the outer perimeter of the coil. These dimensions can provide effective heating of the susceptor arrangement, while retaining a compact outer size.

In some example devices, the first and second coils are substantially contiguous. In other words, they are directly adjacent to each other and are in contact with each other. Such an arrangement can simplify the assembly process of the device. In some examples they are directly adjacent to each other but they are not in contact with each other.

In some examples the midpoint of the length dimension of the second coil is displaced along the longitudinal axis of the device/susceptor such that it is outside of the first coil.

In some examples, the first and second coils being adjacent in a direction along the longitudinal axis can mean that the first and second coils are not aligned along an axis. For example, they may be displaced from each other in a direction perpendicular to the longitudinal axis.

The first coil and second coil may be helical. For example, they may be wound in a helical fashion.

The first coil may comprise a first wire, wound (helically) at a first pitch, and second coil may comprise a second wire, wound (helically) at a second pitch. The pitch is the length of the coil (measured along the longitudinal axis of the device/susceptor/coil) over one complete winding.

The first coil and the second coil may have different pitches. This allows the heating effect of the susceptor arrangement to be tailored for a particular purpose. For example, a shorter pitch can induce a stronger magnetic field. Conversely, a longer pitch can induce a weaker magnetic field.

In an example, the second pitch is longer than the first pitch. This can help reduce the temperature of the produced aerosol in this area. In particular, the second pitch may be longer than the first pitch by less than about 0.5 mm, or by less than about 0.2 mm, or more preferably by about 0.1 mm.

In one arrangement, both the first and second pitches are between about 2 mm and about 4 mm, or between about 2 mm and about 3 mm, or preferably between about 2.5 mm and about 3 mm. For example, the first pitch may be about 2.8 mm and the second pitch may be about 2.9 mm. It has been found that these particular pitches provide optimum heating of the aerosol generating material.

Alternatively, the first coil and the second coil may have substantially the same pitch. This can make it easier and simpler to manufacture the coils. In one example, the pitch is between about 2 mm and about 4 mm, or may be between about 3 mm and about 4 mm, or may be between about 3 mm and about 3.5 mm, or may be greater than about 2 mm or greater than about 3 mm, and/or be less than about 4 mm and/or less than about 3.5 mm.

The first length (of the first coil) may be between about 14 mm and about 23 mm, such as between about 14 mm and about 21 mm, and the second length (of the second coil) may be between about 23 mm and about 30 mm, such as between about 25 mm and about 30 mm. More particularly, the first length may be about 19 mm (±2 mm) and the second length may be about 25 mm (±2 mm). It has been found that these lengths are particularly suitable for providing effective heating of the susceptor, while reducing hot puff. In another example, the first length may be about 20 mm (±1 mm) and the second length may be about 27 mm (±1 mm).

The first coil may comprise a first wire which has a length between about 250 mm and about 300 mm, and the second coil may comprise a second wire which has a length between about 400 mm and about 450 mm. In other words, the length of the wire within each coil is the length when the coil is unraveled. For example, the first wire may have a length between about 300 mm and about 350 mm, such as between about 310, and about 320 mm. The second wire may have a length between about 350 mm and about 450 mm, such as between about 390 mm and about 410 mm. In a particular arrangement, the first wire has a length of about 315 mm, and the second wire has a length of about 400 mm. It has been found that these lengths are particularly suitable for providing effective heating of the susceptor, while reducing hot puff.

The first coil may have between about 5 and 7 turns, and the second coil may have between about 8 and 9 turns. In other words, the first wire and the second wire may be wound this many times. A turn is one complete rotation around an axis. In a particular example, the first coil has between about 6 and 7 turns, such as about 6.75 turns. The second coil may have about 8.75 turns. This allows the ends of the coils to be connected to terminals (such as on a printed circuit board) at a similar place. In a different example, the first coil has between about 5 and 6 turns, such as about 5.75 turns. The second coil may have about 8.75 turns.

The first coil may comprise gaps between successive turns and each gap may have a length of between about 1.4 mm and about 1.6 mm, such as about 1.5 mm. The second coil may comprise gaps between successive turns and each gap may have a length of between about 1.4 mm and about 1.6 mm, such as about 1.6 mm. In some examples the heating effect of the susceptor arrangement can be different for each coil. More generally, the gaps between successive turns may be different for each coil. The gap length is measured in a direction parallel to the longitudinal axis of the device/susceptor/coil. A gap is a portion where no wire of the coil is present (i.e. there is a space between successive turns).

The first coil may have a mass between about 1 g and about 1.5 g, and the second coil may have a mass between about 2 g and about 2.5 g. For example, the first mass may be less than about 1.5 g, and the second mass may be greater than about 2 g. In a particular arrangement, the first coil has a mass of between about 1.3 g and about 1.6 g, such as 1.4 g and the second coil has a mass of between about 2 g and about 2.2 g such as about 2.1 g.

The device may further comprise a controller configured to energize/activate the first coil and the second coils sequentially and to energize/activate the first coil before the second coil. Thus, in use, the first coil is operated first, and the second coil is operated second.

The susceptor arrangement may be hollow and/or substantially tubular to allow the aerosol generating material to be received within the susceptor, such that the susceptor surrounds the aerosol generating material.

In other examples there may be three coils, or four coils, where the coil closest to the mouth end of the device is shorter than each of the other coils.

In another example, the first length (of the first coil) may be between about 10 mm and about 21 mm, and the second length (of the second coil) may be between about 18 mm and about 30 mm (provided the first coil is shorter than the second coil). In one example, the first length may be about 17.9 mm (±1 mm) and the second length may be about 20 mm (±1 mm). In another example, the first length may be about 10 mm (±1 mm) and the second length may be about 21 mm (±1 mm). In another example, the first length may be about 14 mm (±1 mm) and the second length may be about 20 mm (±1 mm).

In some examples, each coil may have the same number of turns.

In some examples, the heater component/susceptor may comprise at least two materials capable of being heated at two different frequencies for selective aerosolization of the at least two materials. For example, a first section of the heater component may comprise a first material, and a second section of the heater component may comprise a second, different material. Accordingly, an aerosol provision device may comprise a heater component configured to heat aerosol generating material, wherein the heater component comprises a first material and a second material, wherein the first material is heatable by a first magnetic field having a first frequency and the second material is heatable by a second magnetic field having a second frequency, wherein the first frequency is different to the second frequency. The first and second magnetic fields may be provided by a single coil or two coils, for example.

Preferably, the device is a tobacco heating device, also known as a heat-not-burn device.

As briefly mentioned above, in some examples, the coil(s) is/are configured to, in use, cause heating of at least one electrically-conductive heating component/element (also known as a heater component/element), so that heat energy is conductible from the at least one electrically-conductive heating component to aerosol generating material to thereby cause heating of the aerosol generating material.

In some examples, the coil(s) is/are configured to generate, in use, a varying magnetic field for penetrating at least one heating component/element, to thereby cause induction heating and/or magnetic hysteresis heating of the at least one heating component. In such an arrangement, the (or each) heating component may be termed a “susceptor.” A coil that is configured to generate, in use, a varying magnetic field for penetrating at least one electrically-conductive heating component, to thereby cause induction heating of the at least one electrically-conductive heating component, may be termed an “induction coil” or “inductor coil.”

The device may include the heating component(s), for example electrically-conductive heating component(s), and the heating component(s) may be suitably located or locatable relative to the coil(s) to enable such heating of the heating component(s). The heating component(s) may be in a fixed position relative to the coil(s). Alternatively, the at least one heating component, for example at least one electrically-conductive heating component, may be included in an article for insertion into a heating zone of the device, wherein the article also comprises the aerosol generating material and is removable from the heating zone after use. Alternatively, both the device and such an article may comprise at least one respective heating component, for example at least one electrically-conductive heating component, and the coil(s) may be to cause heating of the heating component(s) of each of the device and the article when the article is in the heating zone.

In some examples, the coil(s) is/are helical. In some examples, the coil(s) encircles at least a part of a heating zone of the device that is configured to receive aerosol generating material. In some examples, the coil(s) is/are helical coil(s) that encircles at least a part of the heating zone. The heating zone may be a receptacle, shaped to receive the aerosol generating material.

In some examples, the device comprises an electrically-conductive heating component that at least partially surrounds the heating zone, and the coil(s) is/are helical coil(s) that encircles at least a part of the electrically-conductive heating component. In some examples, the electrically-conductive heating component is tubular. In some examples, the coil is an inductor coil.

A third aspect of the present disclosure defines a first coil and a second coil. The first coil has a first length, and the second coil has a second length, where the ratio of the second length to the first length is greater than about 1.1. The first length is therefore shorter than the second length and the second length is at least 1.1 times as long as the first length. Accordingly, the device has an asymmetric heating arrangement of coils. It will be appreciated that this asymmetric heating arrangement is also applicable to other heating technologies, such as resistive heating, where first and second heater resistive heater components may replace the first and second coils.

The first coil may be a first inductor coil, the second coil may be a second inductor coil and the heater component may be a susceptor (also known as a susceptor arrangement).

By having two coils of different lengths, different volumes of aerosol generating material are heated by each coil. For the shorter coil, a smaller volume of aerosol is generally produced than would have been produced had a larger volume of material been heated. The longer coil therefore heats a larger volume of aerosol generating material to produce more aerosol. Thus, by having coils of different lengths, a desired volume of aerosol can be released by operating the relevant coil.

In the above arrangement, the produced aerosol is mixed with substantially the same volume of ambient/cooler air in the device, regardless of which coil causes the aerosol to be released. The ambient air cools the temperature of the produced aerosol. Depending upon which coil is arranged closer to the proximal end (mouth end) of the device will affect the temperature of the aerosol inhaled by the user.

It has been found that when the ratio of the second length to the first length is greater than about 1.1, the volume and temperature of produced aerosol can be tailored to suit a user's needs. In addition, the use of two heating zones provides more flexibility as to how the aerosol generating material is heated.

Furthermore, the shorter coil heats a shorter portion of the susceptor (and thus a shorter portion of the aerosol generating material) with a quicker ramp up time. Therefore, in a session, different sensory properties can be introduced in a more accented manner. For example, if the shorter coil is arranged at the mouth end (proximal end) of the device, the first puff taken by the user can be achieved quickly. If the shorter coil is arranged elsewhere, then additional sensory properties can be introduced quickly over background sensory properties. If the shorter coil is at the distal end, then a particularly pronounced sensory can be brought it at the end of a session, e.g. to overcome off-notes that may be generated by continued heating of downstream portions of the tobacco via the other coils simultaneously.

The ratio may be greater than 1.2. In a particular arrangement, the ratio is between about 1.2 and about 3. When the radio is less than about 3, the volume and temperature of produced aerosol can be better tailored to suit a user's needs. Preferably, the ratio is between about 1.2 and about 2.2, or between about 1.2 and about 1.5. More preferably, the ratio is between about 1.3 and about 1.4. It has been found that this ratio provides a good balance between the above-mentioned considerations.

The first length (of the first coil) may be between about 14 mm and about 23 mm, such as between about 14 mm and about 21 mm. More particularly, the first length may be about 19 mm (±2 mm). The second length (of the second coil) may be between about 20 mm and about 30 mm or between about 25 mm and about 30 mm. More particularly, the second length may be about 25 mm (±2 mm). It has been found that these lengths are particularly suitable for providing effective heating of the susceptor, to ensure a desired volume and temperature of aerosol is produced. In another example, the first length may be about 20 mm (±1 mm) and the second length may be about 27 mm (±1 mm).

Preferably the first length is about 20 mm, and the second length is about 27 mm, such that the ratio is between about 1.3 and about 1.4. These dimensions have been found to provide a good configuration.

In a particular arrangement, in use, the aerosol is drawn along a flow path of the device towards a proximal end of the device, and the first coil is arranged closer to the proximal end of the device than the second coil. As mentioned above, it has been found that by having a shorter coil arranged closer to the proximal end of the device, the phenomenon known as “hot puff” can be reduced or avoided.

It has been found that when the ratio of the second length to the first length is greater than about 1.1 (and less than about 3, such as less than about 2.2, or less than about 1.5, or less than about 1.4), the desired temperature and volume of aerosol can be produced by both coils, without causing harm or discomfort for the user.

The device may further comprise a mouthpiece/opening arranged at the proximal end of the device, wherein the first coil is positioned closer to the mouthpiece than the second coil. The mouthpiece may be removably affixed to an opening of the device, or the opening of the device may itself define a mouthpiece. In a particular example, an article comprising the aerosol generating material is inserted into the device and extends out of the opening of the device while it is being heated. Thus, the aerosol flows out of the opening, but is contained within the article as it does so. In such a case, the opening may still be said to be a mouthpiece, regardless of whether it comes into contact with the user's mouth in use.

In a particular example, the aerosol provision device comprises the susceptor arrangement. In other examples, an article comprising aerosol generating material comprises the susceptor arrangement.

In certain arrangements, an outer perimeter of the first coil is positioned away from the susceptor by substantially the same distance as an outer perimeter of the second coil. In other words, the coils do not overlap each other. Such an arrangement can simplify the assembly process of the device. For example, the two coils can be wrapped around an insulating member. Reference to the “outer perimeter” or “outer surface” of the coil means the edge/surface positioned furthest away from the susceptor arrangement, in a direction perpendicular to the longitudinal axis of the device and/or susceptor arrangement. Similarly, reference to an “inner perimeter/surface” of the coil means the edge/surface positioned closest to the susceptor arrangement, in a direction perpendicular to the longitudinal axis of the device and/or susceptor arrangement. Accordingly, the first and second coils may have substantially the same external diameter.

In one example, the inner diameter of the first and second coils are about 10-14 mm in length, and the outer diameter is about 12-16 mm in length. In a particular example, the inner diameter of the first and second coils is about 12-13 mm in length, and the outer diameter is about 14-15 mm in length. Preferably the inner diameter of the first and second coils is about 12 mm in length, and the outer diameter is about 14.6 mm in length. The inner diameter of a helical coil is any straight line segment that passes through the center of the coil (as viewed in cross section) and whose endpoints lie on the inner perimeter of the coil. The outer diameter of a helical coil is any straight line segment that passes through the center of the coil (as viewed in cross section) and whose endpoints lie on the outer perimeter of the coil. These dimensions can provide effective heating of the susceptor arrangement.

In some example devices, the first and second coils are substantially contiguous. In other words, they are directly adjacent to each other and are in contact with each other. Such an arrangement can simplify the assembly process of the device. In some examples they are directly adjacent to each other but they are not in contact with each other.

In some examples the midpoint of the length dimension of the second coil is displaced along the longitudinal axis of the device/susceptor such that it is outside of the first coil.

In some examples, the first and second coils being adjacent in a direction along the longitudinal axis can mean that the first and second coils are not aligned along an axis. For example, they may be displaced from each other in a direction perpendicular to the longitudinal axis.

The first coil and second coil may be helical. For example, they may be wound in a helical fashion.

The first coil may comprise a first wire, wound (helically) at a first pitch, and second coil may comprise a second wire, wound (helically) at a second pitch. The pitch is the length of the coil (measured along the longitudinal axis of the device/susceptor/coil) over one complete winding.

The first coil and the second coil may have different pitches. This allows the heating effect of the susceptor arrangement to be tailored for a particular purpose. For example, a shorter pitch can induce a stronger magnetic field. Conversely, a longer pitch can induce a weaker magnetic field.

In an example, the second pitch is longer than the first pitch. This can help reduce the temperature of the produced aerosol in this area. In particular, the second pitch may be longer than the first pitch by less than about 0.5 mm, or by less than about 0.2 mm, or more preferably by about 0.1 mm.

In one arrangement, both the first and second pitches are between about 2 mm and about 4 mm, or between about 2 mm and about 3 mm, or preferably between about 2.5 mm and about 3 mm. For example, the first pitch may be about 2.8 mm and the second pitch may be about 2.9 mm. It has been found that these particular pitches provide optimum heating of the aerosol generating material.

Alternatively, the first coil and the second coil may have substantially the same pitch. This can make it easier and simpler to manufacture the coils. In one example, the pitch is between about 2 mm and about 3 mm, or may be between about 2.5 mm and about 3 mm, or may be between about 2.8 mm and about 3 mm, or may be greater than about 2.5 mm or greater than about 2.8 mm, and/or be less than about 3 mm.

The first coil may comprise a first wire which has a length between about 250 mm and about 300 mm, and the second coil may comprise a second wire which has a length between about 400 mm and about 450 mm. In other words, the length of the wire within each coil is the length when the coil is unraveled. For example, the first wire may have a length between about 300 mm and about 350 mm, such as between about 310, and about 320 mm. The second wire may have a length between about 350 mm and about 450 mm, such as between about 390 mm and about 410 mm. In a particular arrangement, the first wire has a length of about 315 mm, and the second wire has a length of about 400 mm. It has been found that these lengths are particularly suitable for providing effective heating of the susceptor, while reducing hot puff.

The first coil may have between about 5 and 7 turns, and the second coil may have between about 8 and 9 turns. In other words, the first wire and the second wire may be wound this many times. A turn is one complete rotation around an axis. In a particular example, the first coil has between about 6 and 7 turns, such as about 6.75 turns. The second coil may have about 8.75 turns. This allows the ends of the coils to be connected to terminals (such as on a printed circuit board) at a similar place. In a different example, the first coil has between about 5 and 6 turns, such as about 5.75 turns. The second coil may have about 8.75 turns.

The first coil may comprise gaps between successive turns and each gap may have a length of between about 1.4 mm and about 1.6 mm, such as about 1.5 mm. The second coil may comprise gaps between successive turns and each gap may have a length of between about 1.4 mm and about 1.6 mm, such as about 1.6 mm. In some examples the heating effect of the susceptor arrangement can be different for each coil. More generally, the gaps between successive turns may be different for each coil. The gap length is measured in a direction parallel to the longitudinal axis of the device/susceptor. A gap is a portion where no wire of the coil is present (i.e. there is a space between successive turns).

The first coil may have a mass between about 1 g and about 1.5 g, and the second coil may have a mass between about 2 g and about 2.5 g. For example, the first mass may be less than about 1.5 g, and the second mass may be greater than about 2 g. In a particular arrangement, the first coil has a mass of between about 1.3 g and about 1.6 g, such as 1.4 g and the second coil has a mass of between about 2 g and about 2.2 g such as about 2.1 g.

The device may further comprise a controller configured to energize/activate the first coil and the second coils sequentially and to energize/activate the first coil before the second coil. Thus, in use, the first coil is operated first, and the second coil is operated second.

The susceptor arrangement may be hollow and/or substantially tubular to allow the aerosol generating material to be received within the susceptor, such that the susceptor surrounds the aerosol generating material.

In other examples there may be three coils, or four coils. In certain arrangements the coil closest to the mouth end of the device is shorter than each of the other coils.

In another example, the first length (of the first coil) may be between about 10 mm and about 21 mm, and the second length (of the second coil) may be between about 18 mm and about 30 mm (provided the first coil is shorter than the second coil). In one example, the first length may be about 17.9 mm (±1 mm) and the second length may be about 20 mm (±1 mm). In another example, the first length may be about 10 mm (±1 mm) and the second length may be about 21 mm (±1 mm). In another example, the first length may be about 14 mm (±1 mm) and the second length may be about 20 mm (±1 mm).

In some examples, the heater component/susceptor may comprise at least two materials capable of being heated at two different frequencies for selective aerosolization of the at least two materials. For example, a first section of the heater component may comprise a first material, and a second section of the heater component may comprise a second, different material. Accordingly, an aerosol provision device may comprise a heater component configured to heat aerosol generating material, wherein the heater component comprises a first material and a second material, wherein the first material is heatable by a first magnetic field having a first frequency and the second material is heatable by a second magnetic field having a second frequency, wherein the first frequency is different to the second frequency. The first and second magnetic fields may be provided by a single coil or two coils, for example.

In some examples, each coil may have the same number of turns.

In some examples there may be three coils, or four coils. In certain arrangements the coil closest to the mouth end of the device is shorter than each of the other coils.

The device, coils or heater component described in relation to the third, fourth or fifth aspects may comprise any or all of the dimensions or features described in relation to any of the other aspects described.

A sixth aspect of the present disclosure defines a first inductor coil which is configured to generate a varying magnetic field for penetrating and heating a susceptor. The susceptor may define a longitudinal axis, and the first inductor coil has a first length along the longitudinal axis. Alternatively, the first inductor coil may define a longitudinal axis. The first inductor coil is helical, and therefore comprises a first number of turns around the longitudinal axis, as it is wound helically around the susceptor. A turn is one complete rotation about the susceptor/axis. It has been found that when the ratio of the number of turns to the length of an inductor coil is between about 0.2 mm⁻¹ and about 0.5 mm⁻¹, the inductor coil generates a magnetic field that is particularly effective at heating a susceptor arranged within the inductor coil. In certain arrangements, such a magnetic field can cause the susceptor to be heated to about 250° C. within less than about 2 seconds, for example. The ratio of the number of turns to the length of an inductor coil may be referred to as the “turn density”, for example. An inductor coil with a turn density between about 0.2 mm⁻¹ and about 0.5 mm⁻¹ is a good balance between ensuring effective and quick heating (with a higher turn density) and ensuring that the device is relatively lightweight and relatively inexpensive to manufacture (with a lower turn density). Moreover, a higher turn density can result in higher resistive losses in the wire forming the inductor coil, and can reduce the air-gap spacing between consecutive turns in the inductor coil. Both of these effects can cause the outer surface of the device to become hotter, which may be uncomfortable for a user of the device.

In some examples, the ratio of the first number of turns to the first length is between about 0.2 mm⁻¹ and about 0.4 mm⁻¹, or between about 0.3 mm⁻¹ and about 0.4 mm⁻¹. Preferably the ratio of the first number of turns to the first length is between about 0.3 mm⁻¹ and about 0.35 mm⁻¹, such as between about 0.32 mm⁻¹ and about 0.34 mm⁻¹.

In certain examples, the first inductor coil may have a first length that is between about 15 mm and about 21 mm. In certain examples, the first inductor coil may have a first number of turns that is between about 6 and about 7. These lengths and number of turns can provide a turn density within the ranges described above.

Preferably, the first length is between about 18 mm and about 21 mm, and the first number of turns is between about 6.5 and about 7. In a particular example, the first length is about 20 mm (±1 mm) and the first number of turns is between about 6.5 and about 7, such as about 6.75. Such an inductor coil is particularly well suited to heat a susceptor in an aerosol provision device.

The aerosol provision device may comprise a single inductor coil (i.e. the first inductor coil), or may comprise two or more inductor coils.

In a particular example, the device further comprises a second inductor coil having a second length along the longitudinal axis and a second number of turns around the susceptor, and wherein a ratio of the second number of turns to the second length is between about 0.2 mm⁻¹ and about 0.5 mm⁻¹. In some examples, the ratio of the second number of turns to the second length is between about 0.2 mm⁻¹ and about 0.4 mm⁻¹, or between about 0.3 mm⁻¹ and about 0.4 mm⁻¹. Preferably the ratio of the second number of turns to the second length is between about 0.3 mm⁻¹ and about 0.35 mm⁻¹, such as between about 0.32 mm⁻¹ and about 0.34 mm⁻¹.

Thus, the first and second inductor coils may comprise substantially the same, or a similar turn density. In one example, the absolute difference between the ratio of the second number of turns to the second length and the ratio of the first number of turns to the first length is less than about 0.05 mm⁻¹, or less than about 0.01 mm⁻¹, or less than about 0.005 mm⁻¹. In another example, the percentage difference between the ratio of the second number of turns to the second length and the ratio of the first number of turns to the first length may be less than about 15%, or less than about 10%, or less than about 5% or less than about 3% or less than about 1%. Thus, when the first and second inductor coils comprise substantially the same turn density, the susceptor can be heated more evenly along its length. This avoids the aerosol generating material being unevenly heated, which can affect the volume, taste and temperature of aerosol that is being generated.

The first length of the first inductor coil may be different to the second length of the second inductor coil. Similarly, the first number of turns may be different to the second number of turns. Accordingly, although the first and second inductor coils may have different lengths and a different number of turns, they may still have the same turn density.

In certain examples the first length may greater than the second length by at least 5 mm.

In certain examples, the second inductor coil may have a second length that is between about 25 mm and about 30 mm. In certain examples, the second inductor coil may have a second number of turns that is between about 8 and about 9. These lengths and number of turns can provide a turn density within the ranges described above.

Preferably, the second length is between about 25 mm and about 28 mm, and the second number of turns is between about 8.5 and about 9. In a particular example, the second length is about 26 mm (±1 mm) and the second number of turns is between about 8.5 and about 9, such as about 8.75. Such an inductor coil is well suited to heat a susceptor in an aerosol provision device.

In an alternative example, the first inductor coil may have a first length that is between about 15 mm and about 21 mm. In certain examples, the first inductor coil may have a first number of turns that is between about 5 and about 6. Preferably, the first length is between about 17.5 mm and about 18.5 mm, and the first number of turns is between about 5.5 and about 6. In a particular example, the first length is about 17.9 mm (±1 mm) and the first number of turns is between about 5.5 and about 6, such as about 5.75. The ratio of the first number of turns to the first length is between about 0.3 mm⁻¹ and about 0.4 mm⁻¹. More preferably, the ratio is about 0.34 mm⁻¹. The device may further comprise a second inductor coil having a second length along the longitudinal axis and a second number of turns around the susceptor. The second inductor coil may have a second length that is between about 19 mm and about 24 mm. In certain examples, the second inductor coil may have a second number of turns that is between about 6 and about 7. Preferably, the second length is between about 19.5 mm and about 20.5 mm, and the second number of turns is between about 6.5 and about 7. In a particular example, the second length is about 20 mm (±1 mm) and the second number of turns is between about 6.5 and about 7, such as about 6.75. A ratio of the second number of turns to the second length is between about 0.3 mm⁻¹ and about 0.4 mm⁻¹. More preferably, the ratio is about 0.38 mm⁻¹. The ratios for the first and second inductor coils therefore vary by about 0.04 mm⁻¹.

In a particular arrangement, in use, the aerosol is drawn along a flow path of the device towards a proximal end of the device, and the first inductor coil is arranged closer to the proximal end of the device than the second inductor coil.

In some examples, either, or both of the first and second inductor coils are formed from litz wire which comprises a plurality of wire strands. The litz wire may have a circular or rectangular cross-section, for example. Preferably the litz wire has a circular cross section.

A litz wire is a wire comprising a plurality of wire strands which is used to carry alternating current. Litz wire is used to reduce skin effect losses in a conductor, and comprises a plurality of individually insulated wires which are twisted or woven together. The result of this winding is to equalize the proportion of the overall length over which each strand is at the outside of the conductor. This has the effect of distributing the current equally among the wire strands, reducing the resistance in the wire. In some examples the litz wire comprises several bundles of wire strands, where the wire strands in each bundle are twisted together. The bundles of wires are twisted/woven together in a similar way.

In some examples, the litz wires of the inductor coils have between about 50 and about 150 wire strands. It has been found that an inductor coil formed with litz wire having the above-mentioned turn density and this many wire strands is particularly suitable for heating a susceptor used in an aerosol provision device. For example, the strength of the magnetic field induced by the inductor coil is well suited to heat a susceptor arranged in proximity to the inductor coil.

In another example, the litz wires of the inductor coils have between about 100 and about 130 wire strands, or between about 110 and about 120 wire strands. Preferably, litz wires of the inductor coils have about 115 wire strands.

The litz wires may comprise at least four bundles of wire strands. Preferably, the litz wires comprise five bundles. As briefly mentioned above, each bundle comprises a plurality of wire strands and the wire strands in each bundle are twisted together. The bundles of wires can be twisted/woven together in a similar way. The wire strands in all of the bundles add up to the total number of wire strands in the litz wire. There may be the same number of wire strands in each bundle. When the wire strands are bundled together in the litz wire, each wire may spend a more equal amount of time at the outside of the bundle.

Each of the wire strands within the litz wires have a diameter. For example, the wire strands may have a diameter of between about 0.05 mm and about 0.2 mm. In some examples, the diameter is between 34 AWG (0.16 mm) and 40 AWG (0.0799 mm), where AWG is the American Wire Gauge. In another example, the wire strands have a diameter of between 36 AWG (0.127 mm) and 39 AWG (0.0897 mm). In another example, the wire strands have a diameter of between 37 AWG (0.113 mm) and 38 AWG (0.101 mm).

Preferably, the wire strands have a diameter of 38 AWG (0.101 mm), such as about 0.1 mm. It has been found that a litz wire with the above specified number of wire strands and these dimensions provide a good balance between effective heating and ensuring that the aerosol provision device is compact and lightweight.

The litz wires may have a length of between about 300 mm and about 450 mm. For example, a first litz wire of the first inductor coil may have a length between about 300 mm and about 350 mm, such as between about 310 mm and about 320 mm. A second litz wire forming the second inductor coil may have a length of between about 350 mm and about 450 mm, such as between about 390 mm and about 410 mm. The length of the litz wire is the length when the inductor coil is unraveled. In a particular arrangement, the first litz wire has a length of about 315 mm, and the second litz wire has a length of about 400 mm. It has been found that these lengths are suitable for providing effective heating of the susceptor.

The inductor coils may comprise a litz wire wound (helically) with a particular pitch. The pitch is the length of the inductor coil (measured along the longitudinal axis of the device/susceptor) over one complete winding. A shorter pitch can induce a stronger magnetic field. Conversely, a longer pitch can induce a weaker magnetic field.

In one arrangement, a first pitch of the first inductor coil is between about 2 mm and about 3 mm, and a second pitch of the second inductor coil is between about 2 mm and about 3 mm. For example, the first pitch or second pitches may be between about 2.5 mm and about 3 mm. In some examples a difference between the first pitch and the second pitch is less than about 0.1 mm. For example, the first pitch may be about 2.8 mm and the second pitch may be about 2.9 mm. For example, the first pitch may be about 2.81 mm and the second pitch may be about 2.88 mm.

The inductor coils may comprise gaps between successive turns and each gap may have a length of between about 1.4 mm and 1.6 mm, such as between about 1.5 mm and about 1.6 mm. Preferably the gaps are about 1.5 mm or 1.6 mm. In some examples the gaps between successive turns is slightly different for each inductor coil. For example, gaps between successive turns in the first inductor coil may differ from gaps between successive turns in the second inductor coil by less than about 0.1 mm. For example, gaps between successive turns in the first inductor coil may be about 1.51 mm and gaps between successive turns in the second inductor coil may be about 1.58 mm.

The first and second inductor coils may have a mass between about 1 g and about 2.5 g. In a particular arrangement, the first inductor coil has a mass of between about 1.3 g and 1.6 g, such as 1.4 g and the second inductor coil has a mass of between about 2 g and about 2.2 g, such as 2.1 g.

As mentioned, the litz wire can have a circular cross section. The litz wire may have a diameter of between about 1 mm and about 1.5 mm or between about 1.2 mm and about 1.4 mm. Preferably the litz wire has a diameter of about 1.3 mm.

In some examples, in use, the inductor coil is configured to heat the susceptor to a temperature of between about 240° C. and about 300° C., such as between about 250° C. and about 280° C.

The first and/or second inductor coils may be positioned away from an outer surface of the susceptor by a distance of between about 3 mm and about 4 mm. Accordingly, an inner surface of the inductor coils and the outer surface of the susceptor may be spaced apart by this distance. The distance may be a radial distance. It has been found that distances within this range represent a good balance between the susceptor being radially close to the inductor coils to allow efficient heating and being radially distant for improved insulation of the induction coils and insulating member.

In another example, the first and/or second inductor coils may be positioned away from the outer surface of the susceptor by a distance of greater than about 2.5 mm.

In another example, the first and/or second inductor coils may be positioned away from an outer surface of the susceptor by a distance of between about 3 mm and about 3.5 mm. In a further example, the first and/or second inductor coils may be positioned away from an outer surface of the susceptor by a distance of between about 3 mm and about 3.25 mm, for example preferably by about 3.25 mm. In another example, the first and/or second inductor coils may be positioned away from an outer surface of the susceptor by a distance greater than about 3.2 mm. In a further example the first and/or second inductor coils may be positioned away from an outer surface of the susceptor by a distance of less than about 3.5 mm, or by less than about 3.3 mm. It has been found that these distances provide a balance between the susceptor being radially close to the inductor coils to allow efficient heating and being radially distant for improved insulation of the induction coils and insulating member.

In one example, the inner diameter of the first and/or second inductor coils is about 10-14 mm, and the outer diameter is about 12-16 mm. In a particular example, the inner diameter of the first and/or second inductor coils is about 12-13 mm, and the outer diameter is about 14-15 mm. Preferably the inner diameter of the first and/or second inductor coils is about 12 mm, and the outer diameter is about 14.6 mm. The inner diameter of a helical inductor coil is any straight-line segment that passes through the center of the inductor coil (as viewed in cross section) and whose endpoints lie on the inner perimeter of the coil. The outer diameter of a helical inductor coil is any straight-line segment that passes through the center of the inductor coil (as viewed in cross section) and whose endpoints lie on the outer perimeter of the coil. These dimensions can provide effective heating of the susceptor arrangement while retaining a compact outer size.

The device, coils or heater component described in relation to the sixth aspect may comprise any or all of the dimensions or features described in relation to any of the other aspects described.

A seventh aspect of the present disclosure defines first and second inductor coils which are configured to generate a varying magnetic field for penetrating and heating a susceptor. The susceptor may define an axis, such as a longitudinal axis, and the first inductor coil has a first number of turns around the longitudinal axis, and the second inductor coil has a second number of turns around the axis. The first and second inductor coils may therefore be helical. A turn is one complete rotation about the susceptor/axis.

It has been found that when the ratio of the second number of turns to the first number of turns is between about 1.1 and about 1.8 the inductor coils provide a heating profile that is tailored for different portions of the susceptor and aerosol generating material. Thus, in this aspect, the second inductor coil has a greater number of turns than the first inductor coil.

In one example, the first inductor coil has fewer turns because the first inductor coil has a length that is shorter than the length of the second inductor coil. The length of the inductor coil is the length measured along the axis defined by the susceptor. When the first inductor coil has fewer turns and a shorter length that the second inductor coil, the first inductor coil can provide fast initial heating of a smaller area of aerosol generating material. However, if the first number of turns is much less than the second number of turns, the volume of aerosol generating material heated via each inductor coil is too different. This may negatively impact the experience of the user, for example, the user may notice a difference in temperature, volume and concentration of aerosol released when the second inductor coil begins to operate. Having the ratio between about 1.1 and about 1.8 provides a good balance between these considerations.

Alternatively, the first inductor coil may have fewer turns so that the magnetic field generated by the first inductor coil is weaker than the magnetic field generated by the second inductor coil. This may be beneficial if the type/density of aerosol generating material is not constant along its length. For example, there may be two types of aerosol generating material which are to be heated to different temperatures. However, if the first number of turns is much less than the second number of turns, the transition between heating each region may be too noticeable. Having the ratio between about 1.1 and about 1.8 provides a good balance between these considerations.

The first number of turns may be between about 5 and about 7, such as between about 6 and 7. In a particular example the first number of turns is about 6.75. The second number of turns may be between about 8 and about 9. In a particular example the second number of turns is about 8.75. Wire forming the inductor coils may have a circular cross section, for example. It has been found that a circular cross section wire with this number of turns for each inductor coil provides effective heating of the susceptor. Inductor coils with these number of turns provide a good balance between providing an effective magnetic field while providing inductor coils that are relatively lightweight and inexpensive.

The first number of turns may be between about 5 and about 7, such as between about 5 and 6. In a particular example the first number of turns is about 5.75. The second number of turns may be between about 8 and about 9. In a particular example the second number of turns is about 8.75. Wire forming the inductor coils may have a rectangular cross section, for example. It has been found that a rectangular cross section wire with this number of turns for each inductor coil provides effective heating of the susceptor. Inductor coils with these number of turns provide a good balance between providing an effective magnetic field while providing inductor coils that are relatively lightweight and inexpensive.

Preferably, the ratio of the second number of turns to the first number of turns is between about 1.1 and about 1.5, or between about 1.2 and about 1.4, such as between about 1.2 and about 1.3. Still more preferably, the ratio may be between about 1.29 and about 1.3. In another example, the first number of turns may be between about 5 and about 6. In a particular example the first number of turns is about 5.75. The second number of turns may be between about 6 and about 7. In a particular example the second number of turns is about 6.75.

In some examples, the first inductor coil is adjacent the second inductor coil in a direction along the longitudinal axis of the susceptor. Thus, the first and second inductor coils do not overlap.

In some examples, the first and second inductor coils have substantially the same “turn density”, i.e. substantially the same number of turns per unit length of the inductor coil. The first inductor coil may have a first length along the longitudinal axis, and a first turn density, and the second inductor coil may have a second length along the longitudinal axis and a second turn density. The turn density is the number of turns divided by the length of the inductor coil.

In one example the absolute difference between the first turn density and the second turn density is less than about 0.1 mm⁻¹, or less than about 0.05 mm⁻¹, or less than about 0.01 mm⁻¹, or less than about 0.005 mm⁻¹. In another example, the percentage difference between the first turn density and the second turn density may be less than about 15%, or less than about 10%, or less than about 5% or less than about 3% or less than about 1%. Thus, when the first and second inductor coils have a similar, or substantially the same turn density but a different number of turns, the susceptor can be heated more evenly along its full length while controlling the volume of aerosol generating material that is heated.

The first and second turn densities may be between about 0.2 mm⁻¹ and about 0.5 mm⁻¹. In some examples, the first and second turn densities are between about 0.2 mm⁻¹ and about 0.4 mm⁻¹, or between about 0.3 mm⁻¹ and about 0.4 mm⁻¹. Preferably the first and second turn densities are between about 0.3 mm⁻¹ and about 0.35 mm⁻¹, such as between about 0.32 mm⁻¹ and about 0.34 mm⁻¹.

In certain examples, the first inductor coil may have a first length along the axis and the second inductor coil may have a second length along the axis, wherein the first length is between about 14 mm and about 23 mm, such as between about 14 mm and about 21 mm, and the second length is between about 23 mm and about 30 mm, such as between about 25 mm and about 30 mm. Preferably, the first length is between about 18 mm and about 21 mm. In a particular example, the first length is about 20 mm (±1 mm). In certain examples, the second inductor coil may have a second length along the axis that is between about 25 mm and about 30 mm. Preferably, the second length is between about 25 mm and about 28 mm. In a particular example, the second length is about 26 mm (±1 mm). In another example, the first length is about 19 mm (±2 mm) and the second length is about 25 mm (±2 mm).

In certain examples the first length may be greater than the second length by at least 5 mm.

In another example, the first length (of the first coil) may be between about 10 mm and about 21 mm, and the second length (of the second coil) may be between about 18 mm and about 30 mm. In one example, the first length may be about 17.9 mm (±1 mm) and the second length may be about 20 mm (±1 mm). In another example, the first length may be about 10 mm (±1 mm) and the second length may be about 21 mm (±1 mm). In another example, the first length may be about 14 mm (±1 mm) and the second length may be about 20 mm (±1 mm).

In a preferred arrangement, in use, the aerosol is drawn along a flow path of the device towards a proximal end of the device, and the first inductor coil is arranged closer to the proximal end of the device than the second inductor coil. Thus, the inductor coil with fewer turns may be arranged closer to the mouth end of the device. This means that the first inductor coil, with fewer turns, can be energized/activated initially, which allows fast initial heating of the aerosol generating material arranged closest to the mouth of the user. The second inductor coil, with more turns, can be energized later during the heating session. In a preferred arrangement, the first inductor coil has a first length along the axis and the second inductor coil has a second length along the axis, and wherein the first length is shorter than the second length. Thus, the first inductor coil has a shorter length and fewer turns than the second inductor coil. In such an arrangement, the end of the susceptor which is closest to the proximal end of the device is surrounded by the first, shorter inductor coil. Once aerosol generating material is received within the device, aerosol generating material that is arranged towards the proximal end of the device is heated as a result of the first, shorter inductor coil.

By having a shorter inductor coil with fewer turns arranged closer to the proximal end of the aerosol generating material (which is heated first), a smaller volume of aerosol generating material is heated. This reduces the volume of aerosol that is produced than would have been produced had a larger volume of material been heated. This aerosol is mixed with a volume of ambient/cooler air in the device, and the temperature of the aerosol is lowered, thereby avoiding/reducing hot puff.

In some examples, the litz wires of the inductor coils have between about 50 and about 150 wire strands. It has been found that an inductor coil formed with litz wire having the above-mentioned turn density and this many wire strands is particularly suitable for heating a susceptor used in an aerosol provision device. For example, the strength of the magnetic field induced by the inductor coil is well suited to heat a susceptor arranged in proximity to the inductor coil.

In another example, the litz wires of the inductor coils have between about 100 and about 130 wire strands, or between about 110 and about 120 wire strands. Preferably, litz wires of the inductor coils have about 115 wire strands.

The litz wires may comprise at least four bundles of wire strands. Preferably, the litz wires comprise five bundles. As briefly mentioned above, each bundle comprises a plurality of wire strands and the wire strands in each bundle are twisted together. The bundles of wires can be twisted/woven together in a similar way. The wire strands in all of the bundles add up to the total number of wire strands in the litz wire. There may be the same number of wire strands in each bundle. When the wire strands are bundled together in the litz wire, each wire may spend a more equal amount of time at the outside of the bundle.

Each of the wire strands within the litz wires have a diameter. For example, the wire strands may have a diameter of between about 0.05 mm and about 0.2 mm. In some examples, the diameter is between 34 AWG (0.16 mm) and 40 AWG (0.0799 mm), where AWG is the American Wire Gauge. In another example, the wire strands have a diameter of between 36 AWG (0.127 mm) and 39 AWG (0.0897 mm). In another example, the wire strands have a diameter of between 37 AWG (0.113 mm) and 38 AWG (0.101 mm).

Preferably, the wire strands have a diameter of 38 AWG (0.101 mm), such as about 0.1 mm. It has been found that a litz wire with the above specified number of wire strands and these dimensions provide a good balance between effective heating and ensuring that the aerosol provision device is compact and lightweight.

The litz wires may have a length of between about 300 mm and about 450 mm. For example, a first litz wire of the first inductor coil may have a length between about 300 mm and about 350 mm, such as between about 310 mm and about 320 mm. A second litz wire forming the second inductor coil may have a length of between about 350 mm and about 450 mm, such as between about 390 mm and about 410 mm. The length of the litz wire is the length when the inductor coil is unraveled. In a particular arrangement, the first litz wire has a length of about 315 mm, and the second litz wire has a length of about 400 mm. It has been found that these lengths are suitable for providing effective heating of the susceptor.

The inductor coils may comprise a litz wire wound (helically) with a particular pitch. The pitch is the length of the inductor coil (measured along the longitudinal axis of the device/susceptor) over one complete winding. A shorter pitch can induce a stronger magnetic field. Conversely, a longer pitch can induce a weaker magnetic field.

In one arrangement, a first pitch of the first inductor coil is between about 2 mm and about 3 mm, and a second pitch of the second inductor coil is between about 2 mm and about 3 mm. For example, the first pitch or second pitches may be between about 2.5 mm and about 3 mm. In some examples a difference between the first pitch and the second pitch is less than about 0.1 mm. For example, the first pitch may be about 2.8 mm and the second pitch may be about 2.9 mm. For example, the first pitch may be about 2.81 mm and the second pitch may be about 2.88 mm.

The inductor coils may comprise gaps between successive turns and each gap may have a length of between about 1.4 mm and 1.6 mm, such as between about 1.5 mm and about 1.6 mm. Preferably the gaps are about 1.5 mm or 1.6 mm. In some examples the gaps between successive turns is slightly different for each inductor coil. For example, gaps between successive turns in the first inductor coil may differ from gaps between successive turns in the second inductor coil by less than about 0.1 mm. For example, gaps between successive turns in the first inductor coil may be about 1.51 mm and gaps between successive turns in the second inductor coil may be about 1.58 mm. The gap length is measured in a direction parallel to the longitudinal axis of the device/susceptor/inductor coil. A gap is a portion where no wire of the coil is present (i.e. there is a space between successive turns).

The first and second inductor coils may have a mass between about 1 g and about 2.5 g. In a particular arrangement, the first inductor coil has a mass of between about 1.3 g and 1.6 g, such as 1.4 g and the second inductor coil has a mass of between about 2 g and about 2.2 g, such as 2.1 g.

As mentioned, the litz wire can have a circular cross section. The litz wire may alternatively have a rectangular cross section. The rectangle may have two short sides and two long sides, where the dimensions of the sides of the rectangle define the area of the rectangular cross section. Other examples may have a generally square cross section, with four substantially equal sides. The cross-sectional area may be between about 1.5 mm² and about 3 mm². In a preferred example, the cross-sectional area is between about 2 mm² and about 3 mm², or between about 2.2 mm² and about 2.6 mm². Preferably the cross-sectional area is between about 2.4 mm² and about 2.5 mm².

In examples having a rectangular cross section with two short and two long sides, the short sides may have a dimension of between about 0.9 mm and about 1.4 mm, and the long sides may have a dimension of between about 1.9 mm and about 2.4 mm. Alternatively, the short sides may have a dimension of between about 1 mm and about 1.2 mm, and the long sides may have a dimension of between about 2.1 mm and about 2.3 mm. Preferably the short sides have a dimension of about 1.1 mm (±0.1 mm) and the long sides have a dimension of about 2.2 mm (±0.1 mm). In such an example, the cross-sectional area is about 2.42 mm².

The first and/or second inductor coils may be positioned away from an outer surface of the susceptor by a distance of between about 3 mm and about 4 mm. Accordingly, an inner surface of the inductor coils and the outer surface of the susceptor may be spaced apart by this distance. The distance may be a radial distance. It has been found that distances within this range represent a good balance between the susceptor being radially close to the inductor coils to allow efficient heating and being radially distant for improved insulation of the induction coils and insulating member.

In another example, the first and/or second inductor coils may be positioned away from the outer surface of the susceptor by a distance of greater than about 2.5 mm.

In another example, the first and/or second inductor coils may be positioned away from an outer surface of the susceptor by a distance of between about 3 mm and about 3.5 mm. In a further example, the first and/or second inductor coils may be positioned away from an outer surface of the susceptor by a distance of between about 3 mm and about 3.25 mm, for example preferably by about 3.25 mm. In another example, the first and/or second inductor coils may be positioned away from an outer surface of the susceptor by a distance greater than about 3.2 mm. In a further example the first and/or second inductor coils may be positioned away from an outer surface of the susceptor by a distance of less than about 3.5 mm, or by less than about 3.3 mm. It has been found that these distances provide a balance between the susceptor being radially close to the inductor coils to allow efficient heating and being radially distant for improved insulation of the induction coils and insulating member.

In a particular example, the aerosol provision device comprises the susceptor. In other examples, an article comprising aerosol generating material comprises the susceptor.

In one example, the inner diameter of the first and/or second inductor coils is about 10-14 mm, and the outer diameter is about 12-16 mm. In a particular example, the inner diameter of the first and/or second inductor coils is about 12-13 mm, and the outer diameter is about 14-15 mm. Preferably the inner diameter of the first and/or second inductor coils is about 12 mm, and the outer diameter is about 14.6 mm. The inner diameter of a helical inductor coil is any straight-line segment that passes through the center of the inductor coil (as viewed in cross section) and whose endpoints lie on the inner perimeter of the coil. The outer diameter of a helical inductor coil is any straight-line segment that passes through the center of the inductor coil (as viewed in cross section) and whose endpoints lie on the outer perimeter of the coil. These dimensions can provide effective heating of the susceptor arrangement while retaining a compact outer size.

The susceptor may be hollow and/or substantially tubular to allow the aerosol generating material to be received within the susceptor, such that the susceptor surrounds the aerosol generating material.

In some examples, the susceptor comprises one or more features to prevent heat bleed between two heating zones on the susceptor. A zone is defined as a region/section of the susceptor that is surrounded by an inductor coil. For example, if the device comprises first and second inductor coils, the susceptor comprises first and second zones. The susceptor may comprise holes through the susceptor between each zone which can help reduce heat bleed between adjacent zones. Alternatively, the susceptor may comprise notches in the outer surface of the susceptor. Alternatively, the susceptor may have thinner walls at the boundary between adjacent zones. In another example, the susceptor may “bulge” outwards at the positions between adjacent zones to increase the conductive path of the susceptor. The bulging sections may also have a wall that is thinner than the walls of the adjacent zones.

In one example, ends of the susceptor can collect heat from an adjacent heating zone. For example, the end portion may have a greater thermal mass than an adjacent portion. This can act as a heat sink.

The device, coils or heater component described in relation to the seventh aspect may comprise any or all of the dimensions or features described in relation to any of the other aspects described.

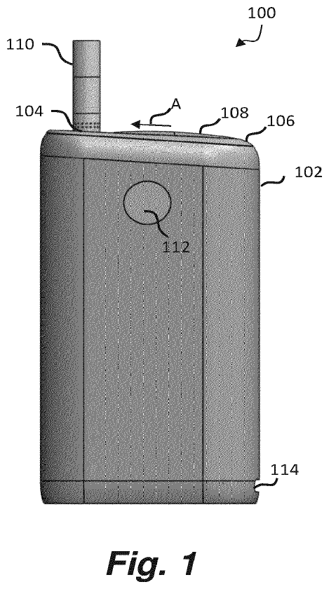

FIG. 1 shows an example of an aerosol provision device 100 for generating aerosol from an aerosol generating medium/material. In broad outline, the device 100 may be used to heat a replaceable article 110 comprising the aerosol generating medium, to generate an aerosol or other inhalable medium which is inhaled by a user of the device 100.

The device 100 comprises a housing 102 (in the form of an outer cover) which surrounds and houses various components of the device 100. The device 100 has an opening 104 in one end, through which the article 110 may be inserted for heating by a heating assembly. In use, the article 110 may be fully or partially inserted into the heating assembly where it may be heated by one or more components of the heater assembly.

The device 100 of this example comprises a first end member 106 which comprises a lid/cap 108 which is moveable relative to the first end member 106 to close the opening 104 when no article 110 is in place. In FIG. 1, the lid 108 is shown in an open configuration, however the lid 108 may move into a closed configuration. For example, a user may cause the lid 108 to slide in the direction of arrow “A”.

The device 100 may also include a user-operable control element 112, such as a button or switch, which operates the device 100 when pressed. For example, a user may turn on the device 100 by operating the switch 112.

The device 100 may also comprise an electrical component, such as a socket/port 114, which can receive a cable to charge a battery of the device 100. For example, the socket 114 may be a charging port, such as a USB charging port.

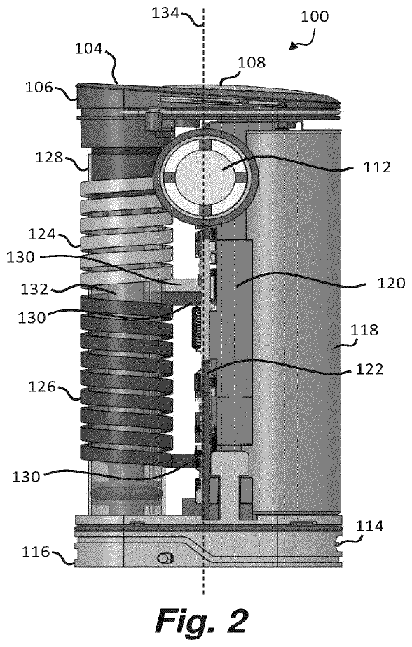

FIG. 2 depicts the device 100 of FIG. 1 with the outer cover 102 removed and without an article 110 present. The device 100 defines a longitudinal axis 134.

As shown in FIG. 2, the first end member 106 is arranged at one end of the device 100 and a second end member 116 is arranged at an opposite end of the device 100. The first and second end members 106, 116 together at least partially define end surfaces of the device 100. For example, the bottom surface of the second end member 116 at least partially defines a bottom surface of the device 100. Edges of the outer cover 102 may also define a portion of the end surfaces. In this example, the lid 108 also defines a portion of a top surface of the device 100.

The end of the device closest to the opening 104 may be known as the proximal end (or mouth end) of the device 100 because, in use, it is closest to the mouth of the user. In use, a user inserts an article 110 into the opening 104, operates the user control 112 to begin heating the aerosol generating material and draws on the aerosol generated in the device. This causes the aerosol to flow through the device 100 along a flow path towards the proximal end of the device 100.

The other end of the device furthest away from the opening 104 may be known as the distal end of the device 100 because, in use, it is the end furthest away from the mouth of the user. As a user draws on the aerosol generated in the device, the aerosol flows away from the distal end of the device 100.

The device 100 further comprises a power source 118. The power source 118 may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery. The battery is electrically coupled to the heating assembly to supply electrical power when required and under control of a controller (not shown) to heat the aerosol generating material. In this example, the battery is connected to a central support 120 which holds the battery 118 in place.

The device further comprises at least one electronics module 122. The electronics module 122 may comprise, for example, a printed circuit board (PCB). The PCB 122 may support at least one controller, such as a processor, and memory. The PCB 122 may also comprise one or more electrical tracks to electrically connect together various electronic components of the device 100. For example, the battery terminals may be electrically connected to the PCB 122 so that power can be distributed throughout the device 100. The socket 114 may also be electrically coupled to the battery via the electrical tracks.

In the example device 100, the heating assembly is an inductive heating assembly and comprises various components to heat the aerosol generating material of the article 110 via an inductive heating process. Induction heating is a process of heating an electrically conducting object (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive heater and the susceptor, allowing for enhanced freedom in construction and application.

The induction heating assembly of the example device 100 comprises a susceptor arrangement 132 (herein referred to as “a susceptor”), a first inductor coil 124 and a second inductor coil 126. The first and second inductor coils 124, 126 are made from an electrically conducting material. In this example, the first and second inductor coils 124, 126 are made from Litz wire/cable which is wound in a helical fashion to provide helical inductor coils 124, 126. Litz wire comprises a plurality of individual wires which are individually insulated and are twisted together to form a single wire. Litz wires are designed to reduce the skin effect losses in a conductor. In the example device 100, the first and second inductor coils 124, 126 are made from copper Litz wire which has a rectangular cross section. In other examples the Litz wire can have other shape cross sections, such as circular.

The first inductor coil 124 is configured to generate a first varying magnetic field for heating a first section of the susceptor 132 and the second inductor coil 126 is configured to generate a second varying magnetic field for heating a second section of the susceptor 132. In this example, the first inductor coil 124 is adjacent to the second inductor coil 126 in a direction along the longitudinal axis 134 of the device 100 (that is, the first and second inductor coils 124, 126 to not overlap). The susceptor arrangement 132 may comprise a single susceptor, or two or more separate susceptors. Ends 130 of the first and second inductor coils 124, 126 can be connected to the PCB 122.

It will be appreciated that the first and second inductor coils 124, 126, in some examples, may have at least one characteristic different from each other. For example, the first inductor coil 124 may have at least one characteristic different from the second inductor coil 126. More specifically, in one example, the first inductor coil 124 may have a different value of inductance than the second inductor coil 126. In FIG. 2, the first and second inductor coils 124, 126 are of different lengths such that the first inductor coil 124 is wound over a smaller section of the susceptor 132 than the second inductor coil 126. Thus, the first inductor coil 124 may comprise a different number of turns than the second inductor coil 126 (assuming that the spacing between individual turns is substantially the same). In yet another example, the first inductor coil 124 may be made from a different material to the second inductor coil 126. In some examples, the first and second inductor coils 124, 126 may be substantially identical.

In this example, the first inductor coil 124 and the second inductor coil 126 are wound in opposite directions. This can be useful when the inductor coils are active at different times. For example, initially, the first inductor coil 124 may be operating to heat a first section/portion of the article 110, and at a later time, the second inductor coil 126 may be operating to heat a second section/portion of the article 110. Winding the coils in opposite directions helps reduce the current induced in the inactive coil when used in conjunction with a particular type of control circuit. In FIG. 2, the first inductor coil 124 is a right-hand helix and the second inductor coil 126 is a left-hand helix. However, in another embodiment, the inductor coils 124, 126 may be wound in the same direction, or the first inductor coil 124 may be a left-hand helix and the second inductor coil 126 may be a right-hand helix.

The susceptor 132 of this example is hollow and therefore defines a receptacle within which aerosol generating material is received. For example, the article 110 can be inserted into the susceptor 132. In this example the susceptor 132 is tubular, with a circular cross section.

The susceptor 132 may be made from one or more materials. Preferably the susceptor 132 comprises carbon steel having a coating of Nickel or Cobalt.

In some examples, the susceptor 132 may comprise at least two materials capable of being heated at two different frequencies for selective aerosolization of the at least two materials. For example, a first section of the susceptor 132 (which is heated by the first inductor coil 124) may comprise a first material, and a second section of the susceptor 132 which is heated by the second inductor coil 126 may comprise a second, different material. In another example, the first section may comprise first and second materials, where the first and second materials can be heated differently based upon operation of the first inductor coil 124. The first and second materials may be adjacent along an axis defined by the susceptor 132, or may form different layers within the susceptor 132. Similarly, the second section may comprise third and fourth materials, where the third and fourth materials can be heated differently based upon operation of the second inductor coil 126. The third and fourth materials may be adjacent along an axis defined by the susceptor 132, or may form different layers within the susceptor 132. Third material may the same as the first material, and the fourth material may be the same as the second material, for example. Alternatively, each of the materials may be different. The susceptor may comprise carbon steel or aluminum for example.

The device 100 of FIG. 2 further comprises an insulating member 128 which may be generally tubular and at least partially surround the susceptor 132. The insulating member 128 may be constructed from any insulating material, such as plastic for example. In this particular example, the insulating member is constructed from polyether ether ketone (PEEK). The insulating member 128 may help insulate the various components of the device 100 from the heat generated in the susceptor 132.

The insulating member 128 can also fully or partially support the first and second inductor coils 124, 126. For example, as shown in FIG. 2, the first and second inductor coils 124, 126 are positioned around the insulating member 128 and are in contact with a radially outward surface of the insulating member 128. In some examples the insulating member 128 does not abut the first and second inductor coils 124, 126. For example, a small gap may be present between the outer surface of the insulating member 128 and the inner surface of the first and second inductor coils 124, 126.

In a specific example, the susceptor 132, the insulating member 128, and the first and second inductor coils 124, 126 are coaxial around a central longitudinal axis of the susceptor 132.

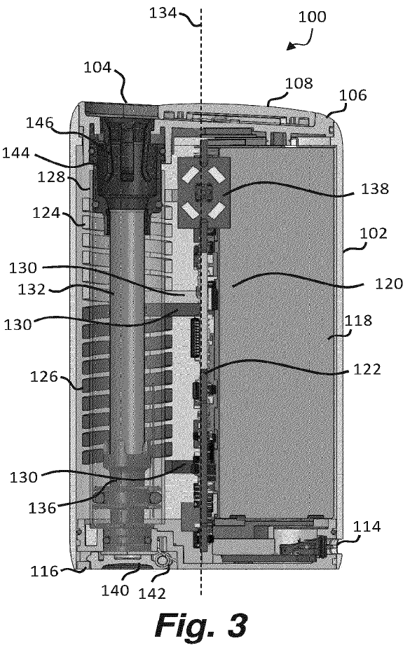

FIG. 3 shows a side view of device 100 in partial cross-section. The outer cover 102 is present in this example. The rectangular cross-sectional shape of the first and second inductor coils 124, 126 is more clearly visible.

The device 100 further comprises a support 136 which engages one end of the susceptor 132 to hold the susceptor 132 in place. The support 136 is connected to the second end member 116.

The device may also comprise a second printed circuit board 138 associated within the control element 112.

The device 100 further comprises a second lid/cap 140 and a spring 142, arranged towards the distal end of the device 100. The spring 142 allows the second lid 140 to be opened, to provide access to the susceptor 132. A user may open the second lid 140 to clean the susceptor 132 and/or the support 136.

The device 100 further comprises an expansion chamber 144 which extends away from a proximal end of the susceptor 132 towards the opening 104 of the device. Located at least partially within the expansion chamber 144 is a retention clip 146 to abut and hold the article 110 when received within the device 100. The expansion chamber 144 is connected to the end member 106.

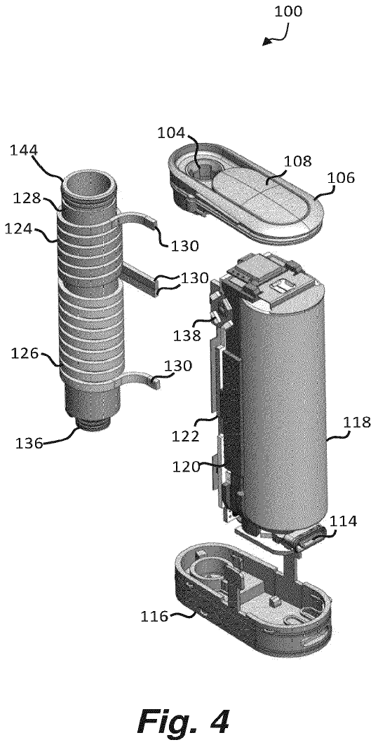

FIG. 4 is an exploded view of the device 100 of FIG. 1, with the outer cover 102 omitted.

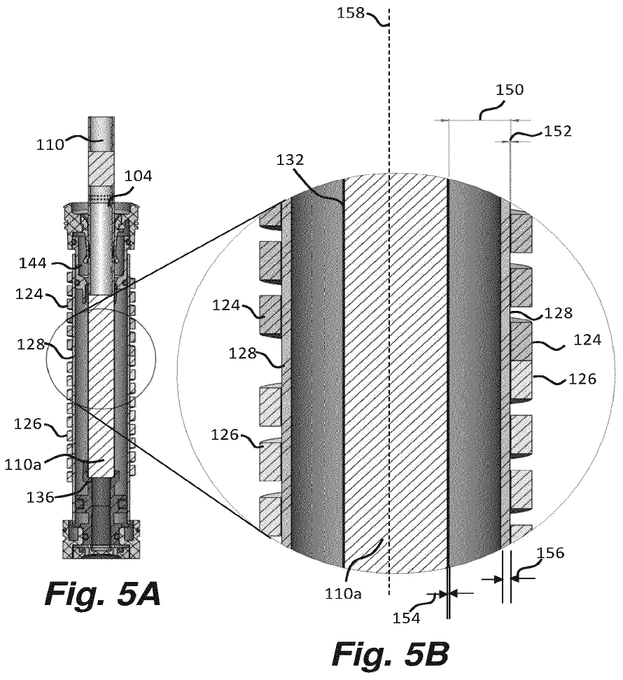

FIG. 5A depicts a cross section of a portion of the device 100 of FIG. 1. FIG. 5B depicts a close-up of a region of FIG. 5A. FIGS. 5A and 5B show the article 110 received within the susceptor 132, where the article 110 is dimensioned so that the outer surface of the article 110 abuts the inner surface of the susceptor 132. This ensures that the heating is most efficient. The article 110 of this example comprises aerosol generating material 110a. The aerosol generating material 110a is positioned within the susceptor 132. The article 110 may also comprise other components such as a filter, wrapping materials and/or a cooling structure.

FIG. 5B shows that the outer surface of the susceptor 132 is spaced apart from the inner surface of the inductor coils 124, 126 by a distance 150, measured in a direction perpendicular to a longitudinal axis 158 of the susceptor 132. In one particular example, the distance 150 is about 3 mm to 4 mm, about 3 mm to 3.5 mm, or about 3.25 mm.

FIG. 5B further shows that the outer surface of the insulating member 128 is spaced apart from the inner surface of the inductor coils 124, 126 by a distance 152, measured in a direction perpendicular to a longitudinal axis 158 of the susceptor 132. In one particular example, the distance 152 is about 0.05 mm. In another example, the distance 152 is substantially 0 mm, such that the inductor coils 124, 126 abut and touch the insulating member 128.

In one example, the susceptor 132 has a wall thickness 154 of about 0.025 mm to 1 mm, or about 0.05 mm.

In one example, the susceptor 132 has a length of about 40 mm to 60 mm, about 40 mm to 45 mm, or about 44.5 mm.

In one example, the insulating member 128 has a wall thickness 156 of about 0.25 mm to 2 mm, 0.25 mm to 1 mm, or about 0.5 mm.

As shown in FIG. 5A, the litz wire of the first inductor coil 124 is wrapped around the axis 158 about 5.75 times, and the litz wire of the second inductor coil 126 is wrapped around the axis 158 about 8.75 times. The litz wires do not form a whole number of turns because some ends of the litz wire are bent away from the surface of the insulating member 128 before a full turn is completed. The ratio of the number of turns in the second inductor coil 126 to the number of turns in the first inductor coil 124 is therefore about 1.5.

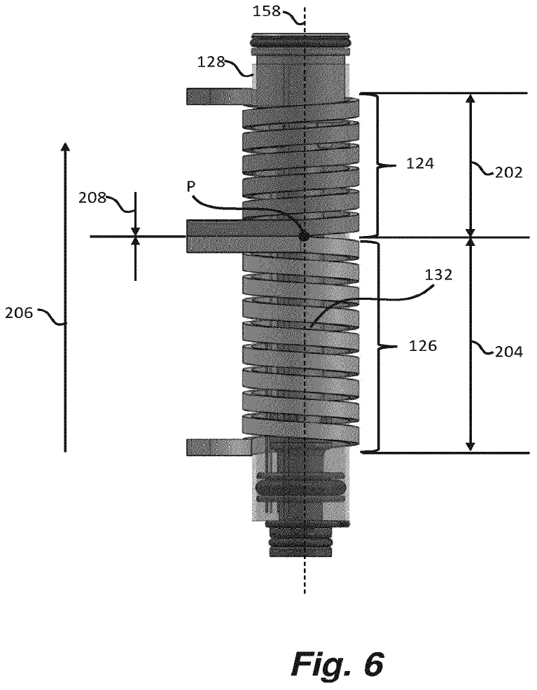

FIG. 6 depicts the heating assembly of the device 100. As briefly mentioned above, the heating assembly comprises a first inductor coil 124 and a second inductor coil 126 arranged adjacent to each other, in the direction along the axis 158 (which is also parallel to the longitudinal axis 134 of the device 100). In use, the first inductor coil 124 is operated initially. This causes a first section of the susceptor 132 to heat up (i.e. the section of the susceptor 132 surrounded by the first inductor coil 124), which in turn heats a first portion of the aerosol generating material. At a later time, the first inductor coil 124 may be switched off, and the second inductor coil 126 may be operated. This causes a second section of the susceptor 132 to heat up (i.e. the section of the susceptor 132 surrounded by the second inductor coil 126), which in turn heats a second portion of the aerosol generating material. The second inductor coil 126 may be switched on while the first inductor coil 124 is being operated, and the first inductor coil 124 may switch off while the second inductor coil 126 continues to operate. Alternatively, the first inductor coil 124 may be switched off before the second inductor coil 126 is switched on. A controller can control when each inductor coil is operated/energized. Thus, the inductor coils 124, 126 may be operated independently of each other.

In a particular example, both inductor coils 124, 126 are operable in two or more different modes. For example, a controller may cause the inductor coils 124, 126 to operate in a first mode wherein the inductor coils 124, 126 are configured to heat the susceptor to a lower temperature than when the inductor coils 124, 126 are operating in a second mode.

In the example shown, the susceptor 132 is unitary, such that the first and second sections are part of a single susceptor 132. In other examples the first and second sections are separate. For example, there may be a gap between the first and second sections. The gap may be an air gap, or a gap provided by non-conductive material.

It has been found that hot puff can be reduced or avoided by making the length 202 of the first inductor coil 124 shorter than the length 204 of the second inductor coil 126. The length of each inductor coil is measured in a direction parallel to the axis of susceptor 158, which is also parallel to the axis of the device 134. Hot puff can be reduced because the volume of aerosol generating material being heated by the first inductor coil 124 is smaller than the volume of aerosol generating material being heated by the second inductor coil 126.

The first, shorter inductor coil 124 is arranged closer to the mouth end (proximal end) of the device 100 than the second inductor coil 126. When the aerosol generating material is heated, aerosol is released. When a user inhales, the aerosol is drawn towards the mouth end of the device 100, in the direction of arrow 206. The aerosol exits the device 100 via the opening/mouthpiece 104, and is inhaled by the user. The first inductor coil 124 is arranged closer to the opening 104 than the second inductor coil 126.

In this example the first and second inductor coils 124, 126 are adjacent and are substantially contiguous. Thus, there is no gap 208 between the inductor coils 124, 126 at point P. In other examples however, there may be a gap that is non-zero. In such a case, the inductor coils 124, 126 would still be adjacent to each other in a direction along the axes 158, 134.

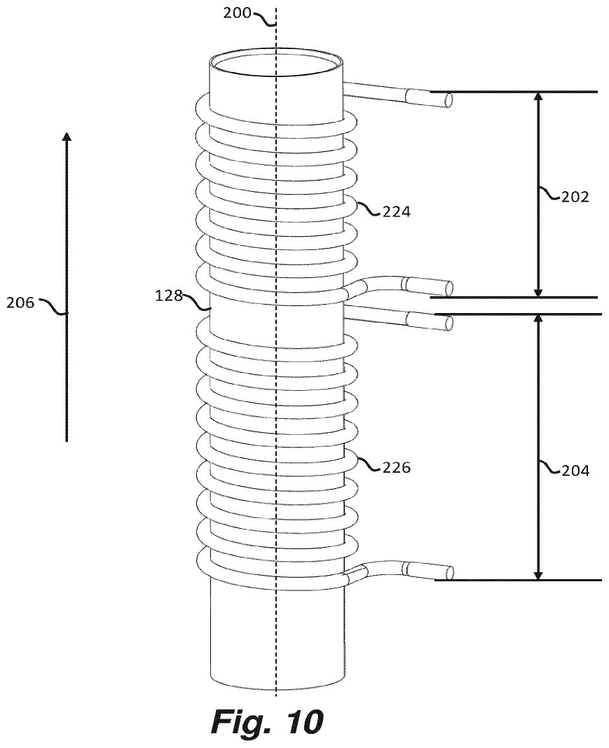

In this example, the first inductor coil 124 has a length 202 of about 20 mm, and the second inductor coil 126 has a length 204 of about 27 mm. A first wire, which is helically wound to form the first inductor coil 124, has an unwound length of about 285 mm. A second wire, which is helically wound to form the second inductor coil 126, has an unwound length of about 420 mm. Although the first and second wires are depicted with a rectangular cross section, they may have a different shape cross section, such as a circular cross section. FIG. 10 depicts an example in which a first inductor coil 224 and a second inductor coil 226 has a circular cross section.

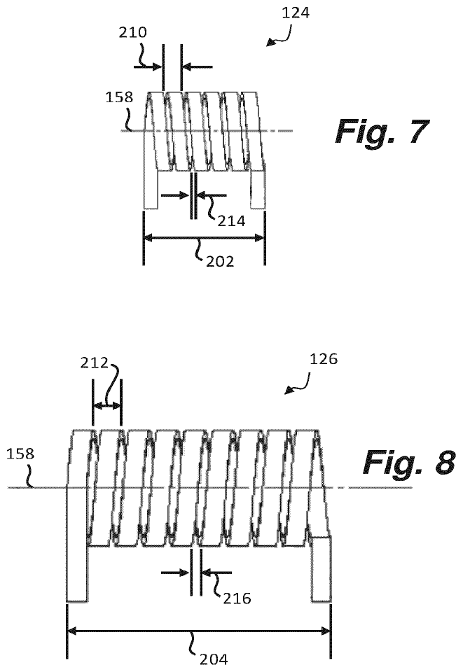

FIG. 7 shows a close up of the first inductor coil 124. FIG. 8 shows a close up of the second inductor coil 126. In this example, the first inductor coil 124 and the second inductor coil 126 have different pitches. The first inductor coil 124 has a first pitch 210, and the second inductor coil has a second pitch 212. The pitch is the length of the inductor coil (measured along the longitudinal axis 134 of the device or along the longitudinal axis 158 of the susceptor or along an axis of an inductor coil) over one complete winding. In another example, each inductor coil may have substantially the same pitch.

FIG. 7 depicts the first inductor coil 124 with about 5.75 turns, where one turn is one complete rotation around the axis 158. Between each successive turn, there is a gap 214. In this example, the length of the gap 214 is about 0.9 mm. Similarly, FIG. 8 depicts the second inductor coil 126 with about 8.75 turns. Between each successive turn, there is a gap 216. In this example, the length of the gap 216 is about 1 mm. In this example, the first inductor coil 124 has a mass of about 1.4 g, and the second inductor coil 126 has a mass of about 2.1 g.

In another example, the first inductor coil 124 has about 6.75 turns. In some examples, the gaps between successive turns may be the same for each inductor coil.

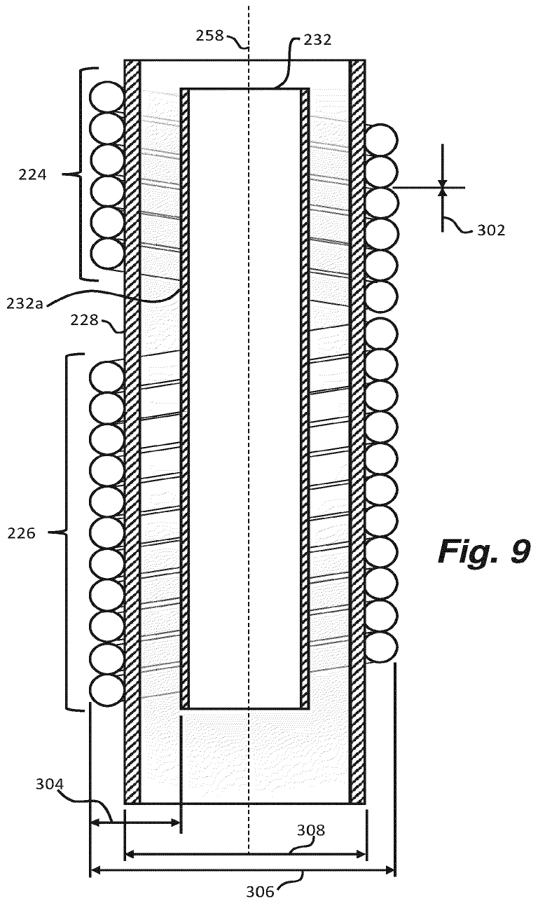

FIG. 9 depicts a diagrammatic representation of a cross section of another heating assembly. The heating assembly may be used in the device 100. The assembly comprises a first inductor coil 224 and a second inductor coil 226 arranged adjacent to each other, in the direction along the longitudinal axis 258 of a susceptor 232 (which is also parallel to the longitudinal axis 134 of the device 100). The susceptor 232 may be substantially the same as the susceptor 132 described in relation to FIGS. 1-8. The first and second inductor coils 224, 226 are helically wound around an insulating member 228, which may be substantially the same as the insulating member 128 described in relation to FIGS. 1-8.

The first and second inductor coils 224, 226 may operate, and be operated, in substantially the same way as the first and second inductor coils 124, 126 described in relation to the FIGS. 1-8. In certain examples, the first inductor coil 224 is arranged closer to the proximal end of the device 100 than the second inductor coil 226. The first inductor coil 224 is shorter than the second inductor coil 226, as measured in a direction parallel to the axes 134, 258.

Unlike the example of FIG. 6, in this heating arrangement the first and second inductor coils 224, 226 are adjacent, but are not contiguous. Thus, there is a gap between the inductor coils 224, 226. In other examples however, there may not be a gap.

In addition, unlike the example of FIGS. 6-8, the first and second wires (which make up the first and second inductor coils 224, 226 respectively) have a circular cross section, however they may be replaced by wires having a different shape cross section.

Furthermore, in this example, there is no gap 302 between successive turns in either of the first and second inductor coils 224, 226.

Further still, in this example, the pitch for both the first and second inductor coils 224, 226 is substantially the same. For example, it may be between about 2 mm and about 4 mm, or be between about 3 mm and about 4 mm.

Other properties and dimensions of the inductor coils 224, 226 may be the same, or different as to those described in relation to FIGS. 6-8.

FIG. 9 depicts the outer perimeter of the first inductor coil 224 being positioned away from the susceptor 232 by a distance 304. Similarly, the outer perimeter of the second inductor coil 226 is positioned away from the susceptor by the same distance 304. Accordingly, the first and second inductor coils have substantially the same external diameter 306. FIG. 9 also depicts the internal diameter 308 of the first and second inductor coils 224, 226 as being substantially the same.

The “outer perimeter” of the inductor coils 224, 226 is the edge of the inductor coil that is positioned furthest away from the outer surface 232a of the susceptor 232, in a direction perpendicular to the longitudinal axis 258.

In FIGS. 6-8, the outer perimeter of the first inductor coil 124 is also positioned away from the susceptor 132 by substantially the same distance as the outer perimeter of the second inductor coil 126.

In one example, the inner diameter of the first and second inductor coils 124, 224, 224, 226 is about 12 mm in length, and the outer diameter is about 14.6 mm in length.

FIG. 10 depicts part of another example heating assembly for use in device 100. In this example, the rectangular cross section litz wires which form the inductor coils have been replaced with inductor coils comprising litz wire with a circular cross section. Other features of the device are substantially the same. The heating assembly comprises a first inductor coil 224 and a second inductor coil 226 arranged adjacent to each other, in the direction along an axis 200. In other example, the wires forming the first and second inductor coils 224, 226 may have a different shape cross section, such as a rectangular cross section.

The axis 200 may be defined by one, or both, of the inductor coils 224, 226 for example. The axis 200 is parallel to the longitudinal axis 134 of the device 100) and is parallel to the longitudinal axis of the susceptor 158. Each inductor coil 224, 226 therefore extends around the axis 200. Alternatively, the axis 200 may be defined by the insulating member 128 or susceptor 132.

The first and second inductor coils 224, 226 are arranged adjacent to each other, in the direction along the axis 200. The inductor coils 224, 226 helically extend around the insulating member 128. The susceptor 132 is arranged within the tubular insulating member 128.

As mentioned in relation to FIG. 6, in use, the first inductor coil 224 is operated initially. However, in another example, the second inductor coil 226 is operated initially.

In certain aspects of the present disclosure, the length 202 of the first inductor coil 224 is shorter than the length 204 of the second inductor coil 226. The length of each inductor coil is measured in a direction parallel to the axis 200 of the inductor coils 224, 226. In some examples the first, shorter inductor coil 224 is arranged closer to the mouth end (proximal end) of the device 100 than the second inductor coil 226, however in other examples, the second longer inductor coil 226 is arranged closer to the proximal end of the device 100.

In one example, the first inductor coil 224 has a length 202 of about 15 mm, and the second inductor coil 226 has a length 204 of about 25 mm. The ratio of the second length 204 to the first length 202 is therefore about 1.7, such as about 1.67. In another example, the first inductor coil 224 has a length 202 of about 15 mm, and the second inductor coil 226 has a length 204 of about 30 mm. The ratio of the second length 204 to the first length 202 is therefore about 2. In another example, the first inductor coil 224 has a length 202 of about 20 mm, and the second inductor coil 226 has a length 204 of about 25 mm. The ratio of the second length 204 to the first length 202 is therefore between about 1.2 and about 1.3, such as about 1.25. In another example, the first inductor coil 224 has a length 202 of about 20 mm, and the second inductor coil 226 has a length 204 of about 30 mm. The ratio of the second length 204 to the first length 202 is therefore about 1.5. In another example, the first inductor coil 224 has a length 202 of about 14 mm, and the second inductor coil 226 has a length 204 of about 28 mm. The ratio of the second length 204 to the first length 202 is therefore about 2. In another example, the first inductor coil 224 has a length 202 of about 15 mm, and the second inductor coil 226 has a length 204 of about 45 mm. The ratio of the second length 204 to the first length 202 is therefore about 3.

In a preferred example, the first inductor coil 224 has a length 202 of between about 19 and 21 mm, such as about 20.3 mm, and the second inductor coil 226 has a length 204 of between about 26 mm and about 28 mm, such as about 26.2 mm. The ratio of the second length 204 to the first length 202 is therefore between about 1.2 and about 1.5, such as about 1.3. As mentioned, in some examples, the first inductor coil 224 has a length 202 of about 20 mm, such as about 20.3 mm and the second inductor coil 226 has a length 204 of about 27 mm, such as about 26.6 mm.

As shown in FIG. 10, the litz wire of the first inductor coil 224 is wrapped around the axis 200 about 6.75 times, and the litz wire of the second inductor coil 226 is wrapped around the axis 200 about 8.75 times. The litz wires do not form a whole number of turns because some ends of the litz wire are bent away from the surface of the insulating member 128 before a full turn is completed. The ratio of the number of turns in the second inductor coil 226 to the number of turns in the first inductor coil 224 is therefore about 1.3.

For the first inductor coil 224, the turn density (i.e. the ratio of the number of turns to the first length 202) is about 0.33 mm⁻¹. For the second inductor coil 226 the turn density (i.e. the ratio of the number of turns to the second length 204) is about 0.33 mm⁻¹. The first and second inductor coils 224, 226 therefore have substantially the same turn density, which results in a more even heating of the susceptor 132 and aerosol generating material 110a.

In other examples, the first inductor coil 224 may have a first length 202 that is between about 15 mm and about 21 mm. The turn density may be between about 0.2 mm⁻¹ and about 0.5 mm⁻¹ but is preferably between about 0.25 mm⁻¹ and about 0.35 mm⁻¹. The second inductor coil 226 may have a second length 204 that is between about 25 mm and about 30 mm. the turn density may be between about 0.2 mm⁻¹ and about 0.5 mm⁻¹ but is preferably between about 0.25 mm⁻¹ and about 0.35 mm⁻¹, such as between about 0.3 mm⁻¹ and about 0.35 mm⁻¹. Turn densities within these ranges are particularly well suited for heating the susceptor 132. In some examples the turn density of the first coil differs from the turn density of the second coil by less than about 0.05 mm⁻¹.

These turn densities may also be applicable to litz wires having different shaped cross sections, such as a rectangular cross-section.

In one example, the first inductor coil 224 has between about 5 turns and about 7 turns. In some examples the second inductor coil 226 has between about 8 and 10 turns. In further examples the inductor coils have a different number of turns to those mentioned. In any case, it is preferred that the ratio of the number of turns in the second inductor coil 126 to the number of turns in the first inductor coil 124 is between about 1.1 and about 1.8.

In one example, a first wire, which is helically wound to form the first inductor coil 224, has an unwound length of about 315 mm. A second wire, which is helically wound to form the second inductor coil 226, has an unwound length of about 400 mm. In another example, a first wire, which is helically wound to form the first inductor coil 224, has an unwound length of about 285 mm. A second wire, which is helically wound to form the second inductor coil 226, has an unwound length of about 420 mm.

Each inductor coil 224, 226 is formed from litz wire comprising a plurality of wire strands. For example, there may be between about 50 and about 150 wire strands in each litz wire. In the present example, there are about 75 wire strands in each litz wire. In some examples, the wire strands are grouped into two or more bundles, where each bundle comprises a number of wire strands such that the wire strands in all bundles add up to the total number of wire strands. In the present example there are 5 bundles of 15 wire strands.

Each of the wire strands have a diameter. For example, the diameter may be between about 0.05 mm and about 0.2 mm. In some examples, the diameter is between 34 AWG (0.16 mm) and 40 AWG (0.0799 mm), where AWG is the American Wire Gauge. In this example, each of the wire strands have a diameter of 38 AWG (0.101 mm). The litz wire may therefore have a radius of between about 1 mm and about 2 mm. In this example, the litz wire has a radius of between about 1.3 mm and about 1.4 mm.

FIG. 10 shows gaps between successive windings/turns. These gaps may be between about 0.5 mm and about 2 mm, for example.

In some examples, each inductor coil 224, 226 has the same pitch, where the pitch is the length of the inductor coil (measured along the axis 200 of the inductor coil or along the longitudinal axis 158 of the susceptor) over one complete winding. In other examples each inductor coil 224, 226 has a different pitch.

In this example, the first inductor coil 224 has a mass of about 1.4 g, and the second inductor coil 226 has a mass of about 2.1 g.

In one example the inner diameter of the first and second inductor coils 224, 224, 224, 226 is about 12 mm in length, and the outer diameter is about 14.6 mm in length.

In a particular example, the first, shorter inductor coil 224 is arranged closer to the mouth end (proximal end) of the device 100 than the second inductor coil 226. When the aerosol generating material is heated, aerosol is released. When a user inhales, the aerosol is drawn towards the mouth end of the device 100, in the direction of arrow 206. The aerosol exits the device 100 via the opening/mouthpiece 104, and is inhaled by the user. The first inductor coil 224 is arranged closer to the opening 104 than the second inductor coil 226. It has been found that hot puff can be reduced or avoided by making the length 202 of the first inductor coil 224 shorter than the length 204 of the second inductor coil 226. Hot puff can be reduced because the volume of aerosol generating material being heated by the first inductor coil 224 is smaller than the volume of aerosol generating material being heated by the second inductor coil 226.

In this example the first and second inductor coils 224, 226 are adjacent and are spaced apart by a gap. In other examples, the first and second inductor coils 224, 226 are substantially contiguous. Thus, there is no gap between the inductor coils 224, 226.

The example inductor coils of FIGS. 7 and 8 may have the same lengths and/or parameters as those described in FIGS. 6 and/or 10. Similarly, the inductor coils of FIGS. 6 and/or 10 may have the same lengths and/or parameters as the inductor coils of FIGS. 7 and 8.

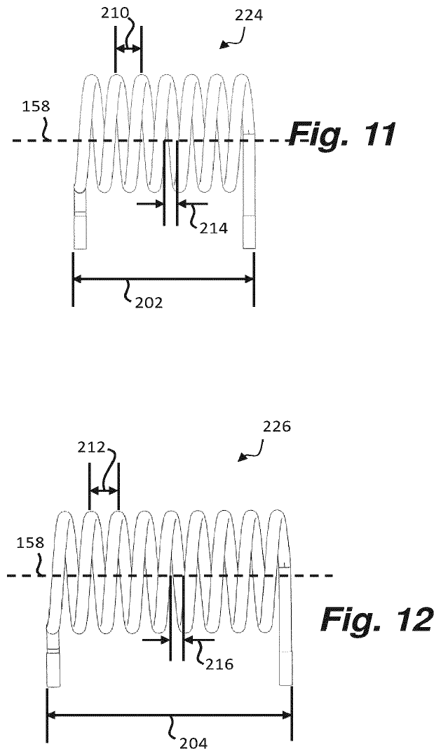

FIG. 11 shows a close up of the first inductor coil 224. FIG. 12 shows a close up of the second inductor coil 226. In this example, the first inductor coil 224 and the second inductor coil 226 have slightly different pitches. The first inductor coil 224 has a first pitch 210, and the second inductor coil has a second pitch 212. In this example, the first pitch is smaller than the second pitch, more specifically the first pitch 210 is about 2.81 mm, and the second pitch 212 is about 2.88 mm. In other example, the pitches are the same for each inductor coil, or the second pitch is smaller than the first pitch.

FIG. 11 depicts the first inductor coil 224 with about 6.75 turns, where one turn is one complete rotation around the axis 158 or the susceptor 132 or axis 200 of the inductor coils 224, 226. Between each successive turn, there is a gap 214. In this example, the length of the gap 214 is about 1.51 mm. Similarly, FIG. 12 depicts the second inductor coil 226 with about 8.75 turns. Between each successive turn, there is a gap 216. In this example, the length of the gap 216 is about 1.58 mm. The gap size is equal to the difference between the pitch and the diameter of the litz wire. Thus, in this example, the litz wire has a diameter of about 1.3 mm.

In this example, the first inductor coil 224 has a mass of about 1.4 g, and the second inductor coil 226 has a mass of about 2.1 g.

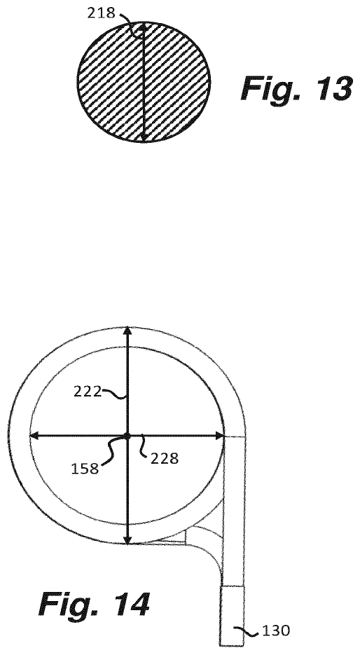

FIG. 13 is a diagrammatic representation of a cross section through the litz wire forming either of the first and second inductor coils 224, 226. As shown, the litz wire has a circular cross section (the individual wires forming the litz wire are not shown for clarity). The litz wire has a diameter 218, which may be between about 1 mm and about 1.5 mm. In this example, the diameter is about 1.3 mm.

FIG. 14 is a diagrammatic representation of a top down view of either of the inductor coils 224, 226. In this example the inductor coil 224, 226 is arranged coaxially with the longitudinal axis 158 of the susceptor 132 (although the susceptor 132 is not depicted for clarity).

FIG. 14 shows the inductor coil 224, 226 with outer diameter 222 and an inner diameter 228. The outer diameter 222 may be between about 12 mm and about 16 mm and the inner diameter 228 may be between about 10 mm and about 14 mm. In this particular example, the inner diameter 228 is about 12.2 mm in length, and the outer diameter 222 is about 14.8 mm in length.

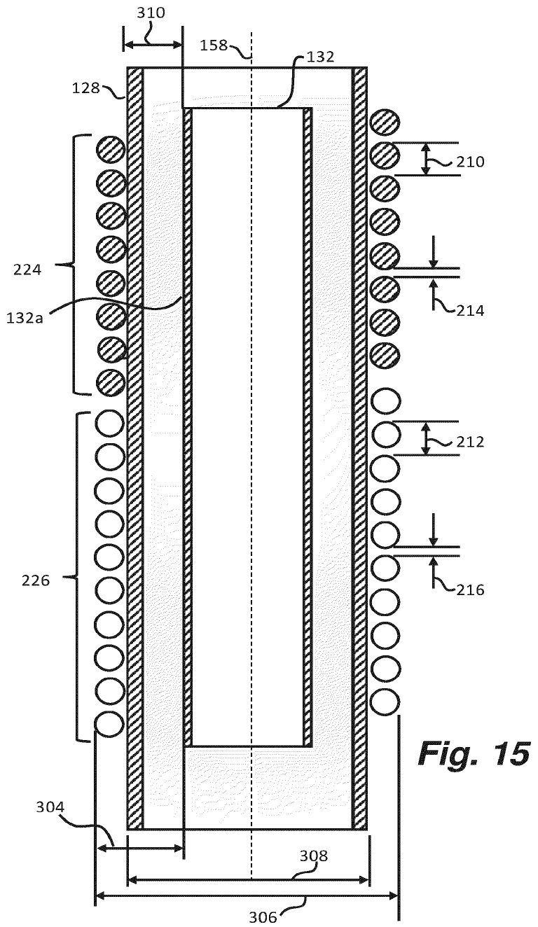

FIG. 15 is another example diagrammatic representation of a cross section of the heating assembly. FIG. 15 depicts the outer perimeter/surface of the inductor coils 224, 226 being positioned away from the susceptor 232 by a distance 304. Accordingly, the first and second inductor coils have substantially the same external diameter 306. FIG. 15 also depicts the internal diameter 308 of the first and second inductor coils 224, 226 as being substantially the same.

The “outer perimeter” of the inductor coils 224, 226 is the edge of the inductor coil that is positioned furthest away from the outer surface 132a of the susceptor 132, in a direction perpendicular to the longitudinal axis 158.

As shown, the inner surfaces of the inductor coils 224, 226 are positioned away from the outer surface 132a of the susceptor 132 by a distance 310. The distance may be between about 3 mm and about 4 mm, such as about 3.25 mm.

Unlike the example of FIG. 9, there are gaps 214, 216 between successive turns in the first and second inductor coils 224, 226.

In an alternative example, a first length (of a first coil) may be between about 14 mm and about 23 mm, and a second length (of a second coil) may be between about 23 mm and about 28 mm. More particularly, the first length may be about 19 mm (±2 mm) and the second length may be about 25 mm (±2 mm). In this alternative example, the first coil may have between about 5 and 7 turns, and the second coil may have between about 4 and 5 turns. For example, the first coil may have about 6.75 turns, and the second coil may have about 4.75 turns. The ratio of number of turns of the longer coil to the number of turns of the shorter coil is therefore about 1.42. In the first coil, the ratio of the number of turns to the length is about 0.36 mm⁻¹. In the second coil, the ratio of the number of turns to the length is about 0.2 mm⁻¹, such as about 0.19 mm⁻¹.

In this alternative example, the second coil may have a pitch that varies across its length. For example, the second coil may have a first number of turns with a first pitch, and a second number of turns with a second pitch, where the second pitch is greater than the first pitch. In a particular example, the second coil has between about 3 and 4 turns with a pitch of between about 2 mm and 3 mm, and one turn with a pitch of between about 18 mm and 22 mm. In particular, the second coil has 3.75 turns with a pitch of 2.81 mm and one turn with a pitch of 20 mm. The second coil may therefore have 4.75 turns in total. The second coil is therefore more tightly wound towards one end of the coil. In one example, a first portion of the second coil has the first number of turns with the first (smaller) pitch, and a second portion of the second coil has the second number of turns with the second (larger) pitch, where the first portion is closer to the proximal/mouth end of the device than the second portion.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1-55. (canceled)

56. An aerosol provision device defining a longitudinal axis, the device comprising:
a first coil and a second coil, wherein:
the first coil is configured to heat a first section of a heater component, the heater component being configured to heat aerosol generating material to generate an aerosol;
the second coil is configured to heat a second section of the heater component; and
the first coil is adjacent the second coil in a direction along the longitudinal axis;
wherein the first and second coils have different pitches.

57. The aerosol provision device of claim 56, wherein the first coil has a first pitch and the second coil has a second pitch, the second pitch being greater than the first pitch.

58. The aerosol provision device of claim 56, wherein, in use, the aerosol is drawn along a flow path of the device towards a proximal end of the device, and the first coil is arranged closer to the proximal end of the device than the second coil.

59. The aerosol provision device of claim 58, further comprising an opening arranged at the proximal end of the device, wherein the first coil is positioned closer to the opening than the second coil.

60. The aerosol provision device of claim 56, wherein the first and second coils are directly adjacent each other.

61. The aerosol provision device of claim 56, wherein the second coil has a pitch that varies across its length.

62. The aerosol provision device of claim 56, wherein the second coil has a first number of turns with a first pitch, and a second number of turns with a second pitch, where the second pitch is greater than the first pitch.

63. The aerosol provision device of claim 62, wherein the second coil is more tightly wound towards one end of the second coil.

64. The aerosol provision device of claim 56, wherein the heater component is a susceptor arrangement.

65. The aerosol provision device of claim 64, wherein the susceptor arrangement comprises a single susceptor comprising a first section of the heater component configured to be heated by the first coil, and a second section of the heater component configured to be heated by the second coil.

66. The aerosol provision device of claim 64, wherein the susceptor arrangement comprises a first susceptor and a second susceptor in axial alignment, the first coil configured to heat the first susceptor, and the second coil configured to heat the second susceptor.

67. The aerosol provision device of claim 56, comprising a heater component configured to heat aerosol generating material to generate an aerosol.

68. The aerosol provision device of claim 67, wherein the heater component defines a receptacle and the heater component is arranged to receive the aerosol generating material.

69. The aerosol provision device of claim 64, wherein the device is arranged to receive an article comprising aerosol generating material, wherein the article comprises the susceptor arrangement.

70. The aerosol provision device according to claim 56, wherein the first coil comprises a different number of turns than the second coil.

71. The aerosol provision device of claim 56, wherein the first and second coils are separate from one another.

72. The aerosol provision device of claim 56, wherein the first and second coils are independently operable.

73. The aerosol provision device according to claim 56, wherein the first and second coils are operated sequentially.

74. The aerosol provision device of claim 56, wherein the first coil has a first length along the longitudinal axis and the second coil has a second length along the longitudinal axis, and the first length is shorter than the second length.

75. An aerosol provision system comprising:
an aerosol provision device according to claim 56; and
an article comprising aerosol generating material
